(19) United States
(12) Patent Application Publication
(10) Pub. No.: US 2026/0103425 A1
(43) Pub. Date: Apr. 16, 2026

(54) CARBONATION OF CONCRETE PRODUCTS

(71) Applicant: CARBONCURE TECHNOLOGIES INC., Dartmouth (CA)

(72) Inventors: Soley EINARSDOTTIR, Halifax (CA); Dean Paul FORGERON, Hacketts Cove (CA); Michael THOMAS, Buckhorn (CA); George Sean MONKMAN, Halifax (CA); Alex HANMORE, Halifax (CA)

(21) Appl. No.: 19/420,406

(22) Filed: Dec. 15, 2025

Related U.S. Application Data
(63) Continuation of application No. 18/034,555, now abandoned.
(60) Provisional application No. 63/107,329, filed on Oct. 29, 2020.

(51) Int. Cl. C04B 20/02; C04B 18/167

(52) U.S. Cl. CPC C04B 20/023; C04B 18/167

(57) ABSTRACT

Provided herein are methods and compositions for carbonation of recycled concrete aggregates (RCA) to produce carbonated RCA. In addition, uses of the carbonated RCA, such as in building materials, and building materials containing RCA, are included. Carbonation of RCA may be used alone or may be used in combination with other carbonation processes associated with concrete manufacture, such as carbonation of wet concrete mixes and/or carbonation of concrete wash water.

### CROSS-REFERENCE

This application is a continuation of U.S. application Ser. No. 18/034,555 filed Apr. 28, 2023, which is a national phase entry of PCT/IB21/00718 filed Oct. 29, 2021, which claims the benefit of U.S. Provisional Application No. 63/107,329 [Attorney docket No. CCT-021.PRO3], filed Oct. 29, 2020, which applications are incorporated herein by reference in their entireties.

### BACKGROUND

Recycled concrete aggregate (RCA) produced, for example, by crushing concrete from structures affected by alkali-silica reaction (ASR) can induce expansion and damage in new concrete produced using the RCA even when preventive measures are implemented to control ASR. The damage can be prevented by carbonating the RCA prior to its use in new concrete. RCA can have other advantages, as well.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a system to store and carbonate recycled aggregate

FIG. 2 shows expansion of concrete prisms stored over water at 38 degrees C. Non-reactive coarse aggregate and Jobe sand.

FIG. 3 shows expansion of concrete prisms stored over water at 38 degrees C. Non-reactive coarse aggregate and Jobe sand, recycled-concrete-coarse-aggregate non-reactive sand

FIG. 4 shows the results for concrete produced with the carbonated RJC material (RJC-CO2) as the coarse aggregate and a non-reactive fine aggregate.

FIG. 5 shows expansion data for the lithium-treated RJC aggregate (RJC-LN) and the 80/20 combination of LA cement/fly ash (LAFA)

FIG. 6 shows a schematic of the RJC (upper left) and the fresh concrete produced with the RJC (upper right)

FIG. 7 shows another aspect of carbonated vs. non-carbonated recycled concrete aggregate

FIG. 8 shows another aspect of carbonated vs. non-carbonated recycled concrete aggregate.

FIG. 9 shows an exemplary embodiment of an aqueous carbonation apparatus.

FIG. 10 shows another exemplary embodiment of an aqueous carbonation apparatus.

FIG. 11 shows a further exemplary embodiment of an aqueous carbonation apparatus.

FIG. 12 shows aggregate carbonation values obtained by mass loss analysis versus carbonation values obtained by TGA testing.

FIG. 13 shows mass change over time for various aggregate mixtures exposed to carbon dioxide.

FIG. 14 shows efficiency of carbonation with increasing number of carbon dioxide additions to a closed system where various aggregate mixtures are exposed to carbon dioxide.

### DETAILED DESCRIPTION

Described herein are methods and compositions for carbonating recycled concrete aggregate and using carbonated concrete aggregate, carbonating recycled concrete aggregate fines, and for carbonating other concrete materials, e.g., concrete returned to a concrete batching facility. Certain methods and compositions are generally applicable, and particularly applicable to recycled concrete aggregate from structures affected by alkali-silica reaction.

Recycled concrete aggregate (RCA) produced by crushing concrete from structures affected by alkali-silica reaction (ASR) can induce expansion and damage in new concrete produced using the RCA even when preventive measures are implemented to control ASR. The damage can be prevented by carbonating the RCA prior to its use in new concrete

The consideration of concrete as a sustainable building material is related to its relatively low embodied emissions per unit mass and low operating emissions associated with the use stage of a building in service. The sustainability of concrete is further demonstrated by considering it to be a recyclable construction material; returned or reclaimed concrete can be crushed for use as aggregates in new construction. The practice not only reduces waste disposal but helps to conserve natural resources and can realize economic benefits.

Recycled concrete processing is often aligned with the demolition of a structure at the end of its service life. In many cases, end of service life is associated with a reduced performance particularly with respect to durability. Insofar as adhered paste is a part of a recycled concrete aggregate (RCA) it can contain ionic species that reflect the nature and exposure history of the source concrete. Such species, like alkalis and chlorides, can have a chemical impact in the new concrete that is unlike that of natural aggregates that might otherwise be used.

One common deleterious durability concern in concrete, particularly one that can be relevant to the end of its service life, is alkali-silica reaction (ASR). Siliceous aggregates in the concrete undergo an expansive reaction with alkali hydroxides from the binder phase. Recycled concrete aggregates (RCA) produced from ASR-affected concrete can contain both reactive silica and additional alkalis either in the adhered mortar or from ASR gel already present in the RCA. The problem of alkali-silica reactions in recycled concrete is a challenge to manage since a shift in the gradation of reactive particles and concentration of alkalis (possibly through crushing of the concrete and/or dilution by changing the concrete to a component of a new concrete mix) can become closer to the pessimum content (a proportion that is an ideal balance between reactive silica and available alkali that will produce the highest expansion) in the recycled aggregate concrete (RAC) than in the original concrete.

The study of RCA produced from recycled concrete that had been affected by ASR has shown that it can be as deleteriously reactive as the siliceous limestone aggregate originally contained within the concrete. As with reactive aggregate, the expansion could be mitigated by replacing part of the cement in the binder with SCMs, albeit at greater levels than required for the original virgin reactive aggregate. Fine RCA was observed to be less reactive than coarse RCA likely due to a reduced proportion of reactive constituents in the small size fraction. Alkali silica reaction in concrete has also been observed to be induced by mortar adhered to recycled aggregate and the amount of adhered mortar can affect the level of reactivity in an aggregate. In limiting the impacts it has been observed that reducing the available alkalis appears to have a greater impact than reducing the calcium availability. There is a clear challenge to recycling ASR-affected or ASR-susceptible concrete for use as aggregates.

It has been established that deliberately pre-carbonating RCAs can improve both the quality of the aggregates and the mechanical properties of concrete produced with such aggregates. It is theorized that CaO from the binder combines with carbon dioxide to form CaCO₃ that precipitates in the pore space of the mortar component present in RCAs and improves the microstructure. The CO₂ treatment of recycled concrete aggregates has been observed to reduce the water absorption of the aggregates and reduce the transport properties of concrete (as measured by bulk electrical conductivity, chloride ion permeability and gas permeability) made with the aggregates as compared to untreated RCA.

The CO₂ treatment of a recycled concrete aggregate and its impact on chemical fluxes into and out of the treated mass may have some similarity to the CO₂ treatment of cement solidified wastes. It has been observed that CO₂ solidification of paste cylinders comprised of dried wastes (mainly heavy metal hydroxides) and cement greatly reduced the leachability of metals contained within the forms. It has been suggested that some metals can be preferentially incorporated in the silica-rich rims of decalcified cement grains, as in the calcite infilling porosity.

Described herein are the impacts of carbonating a recycled concrete aggregate, e.g., that is produced from mortar comprised of a reactive sand and a high-alkali cement. The alkali-silica reaction (ASR) in concrete occurs by reaction of reactive silica phases in the aggregate with alkali and hydroxide ions in the pore solution of the hydrating cement to produce a hydrous alkali silicate gel. The reaction depends not only on sufficient chemical driving forces (alkali concentration and the aggregate's reactivity) but also on the transport of alkali ions. If mobility of the alkali ions in the RCA adhered paste can be reduced, then expansive gel formation may be inhibited.

In general, the methods and compositions disclosed herein relate to treating cement products, such as concrete, where the cement has already hydrated, with carbon dioxide, then reusing the carbonated hydrated cement product. This can be, e.g., used as recycled aggregate. Any carbonation of a hydrated cement product, then reuse of that cement product, is encompassed by the methods and compositions described herein. Thus, the recycled product may be concrete that is carbonated then recycled as aggregate, or some part of a concrete product that is carbonated then recycled. The recycled product may be unused wet concrete, e.g., concrete that is returned or otherwise located at a concrete facility and that is carbonated, then allowed to harden and crushed to provide aggregates. The recycled product may be concrete fines, e.g., fines generated during the processes used to reduce recycled aggregate and/or recycled wet concrete that has been carbonated and hardened, to desired sizes, where the fines are primarily hydrated cement; the fines may, in certain embodiments, be carbonated as part of a wash water carbonation system. The carbonated cement product may be used in any suitable form, e.g., as an aqueous suspension, or as a dried component.

### Carbonating Recycled Aggregates

Any suitable method can be used to carbonate recycled aggregate. In certain embodiments, the aggregate is pre-treated prior to exposure to carbon dioxide. Any suitable pre-treatment can be used. In certain embodiments, the recycled concrete aggregate is processed to reduce its size and/or to provide a uniformly sized particle; for example the recycled concrete aggregate can be crushed, and can be further sized to provide pieces of aggregate for carbonation in a certain size range, for example 0.1 mm-200 mm, or 1 mm-100 mm, or 1 mm-50 mm, or 1 mm-40 mm, or 2 mm-30 mm, or 5 mm-20 mm; in certain cases, fine aggregate (e.g., aggregate of a size less than 1 mm) may be desired, with larger sizes being considered coarse aggregate; crushed aggregate can, e.g., be passed through a series of sieves to provide the desired size range. In certain cases, the aggregate used in certain methods and compositions of the invention can be classified as coarse and/or fine, as those terms are used in the art. For example, fine aggregate may be defined as aggregate nominally with a size less than 1 mm. The exact sizes and acceptable ranges will depend on the intended use; aggregate used in concrete may be a mixture of coarse and fine aggregate (which can be carbonated separately); aggregate used in, e.g., road base applications may be graded from 0 to 25 mm (or even 40 mm). Aggregate sizes and ranges for various uses are well-known in the art.

The recycled concrete aggregate can alternatively or in addition be pre-treated by exposure to air, for example air drying. The period of exposure to air can be any suitable period, for example 1-1000 hours, or 5-500 hours, or 10-200 hours, or 20-150 hours, or 50-100 hours, for example, about 24, 48, 72, or 96 hours.

The recycled concrete aggregate is exposed to carbon dioxide. Any suitable method of exposure may be used, and other conditions adjusted as appropriate.

The source of carbon dioxide may be any suitable source. Sources include air, for example direct air capture integrated into a processing setup or in close proximity to a suitable facility; industrially sourced carbon dioxide, such as merchant market, e.g., byproduct of ethanol, ammonia, or hydrogen productions; point source emissions such as power plants (e.g. coal-fired or natural gas-fired power plants) or cement plants; and/or engine exhaust from vehicles and machinery related to or in the vicinity of the treatment process. The source material is generally treated to concentrate carbon dioxide and render it into a form suitable for transportation to an aggregate treatment site and/or for treatment of the aggregate; in certain cases a source material, e.g., flue gas, may be used as is or with only minimal modification; this can be, e.g., flue gas from a cement plant, which is already high in carbon dioxide. For example, carbon dioxide may be extracted from the source material in a concentration of 10-100%, or 30-100%, or 50-100%, or 70-100%, or 80-100%, or 90-100%, or 95-100%, or 99-100%. In certain embodiments, the carbon dioxide is converted to liquid form for transport; transport of gaseous carbon dioxide is also possible. Carbon dioxide may be transported in any suitable manner, such as by pipeline, rail, truck, and the like.

In certain embodiments, the source of carbon dioxide comprises a cement plant; such plants produce high concentrations of carbon dioxide in flue gas due to both calcining and fuel combustion in the calcining process. The carbon dioxide, e.g., as extracted from the flue gas, may be used in a variety of manners related to concrete production (e.g., as detailed below), including carbonation of aggregates. In certain embodiments, carbon dioxide from a cement plant may be used in the production of concrete using the cement from the cement plant; in general, this reduces both transportation cost and carbon dioxide emission, as the carbon dioxide is transported a relatively short distance from the cement plant to the concrete production facility. The aggregates used in the production of the concrete may include recycled concrete aggregates, some or all of which are carbonated, e.g., as described herein; in certain embodiments the aggregates are carbonated using carbon dioxide from a cement plant, such as the cement plant producing the cement used in the concrete-producing facility. The recycled aggregates may be carbonated at a site in the concrete-producing facility or a separate site, or a combination thereof. In certain embodiments, one or both of cement used in the concrete and/or wash water from the concrete production may also be carbonated with carbon dioxide comprising carbon dioxide from a cement plant, e.g., the same plant as used to produce the cement, and used in the production of the concrete.

In certain embodiments the source of carbon dioxide is a process and/or facility in which carbon dioxide is produced as a byproduct of a desired product, generally at a purity that is, e.g., less than food-grade purity (e.g., less than 99.9% pure, in certain embodiments less than 99% pure). Such processes/facilities include ethanol production from crops such as corn; biogas production, e.g., anaerobic digestion of biological material such as landfill, crop residues, RNG, and the like.

In certain embodiments, the recycled concrete aggregate is placed in an atmosphere in a suitable range of relative humidities, such as 30-80%, or 40-70%, or 50-70%, or 55-65%. The temperature for the carbonation may be any suitable temperature, e.g., 5-50, or 10-50, or 20-50, or 20-40 degrees C. The RCA can be exposed to carbon dioxide-enriched atmosphere, for example 0.1-100%, or 0.1-90%, or 0.1-70%, or 0.1-50%, or 0.1-20%, or 0.1-10%, or 0.5-20%, or 0.5-10%, or 0.5-5%, or 0.5-2% carbon dioxide. The exposure may be continuous or intermittent. The concentration of carbon dioxide during exposure may remain constant or may be altered at one or more times. The total time of exposure may be any suitable time, for example 1-1000 days, or 2-500 days, or 5-500 days, or 10-300 days, or 20-250 days, or 30-250 days, or 50-200 days, or 60-150 days, or 70-120 days, or 80-100 days. After carbonation, the RCA may be used in a concrete mix as is or with further treatment.

Carbonation of recycled concrete aggregates may be performed in any suitable facility. The facility may include one or more of a system for crushing and grading aggregate to the desired sizes and/or a system for transporting crushed and/or graded aggregates to the site; a source of carbon dioxide (e.g., as transported from any of the original sources described herein); a site for aggregate treatment; a system for delivering the carbon dioxide to the aggregate in the desired form and concentration and at the desired rate and time; various monitoring systems, e.g., sensors for one, two, three, four, five, six, or all of temperature, moisture content, pressure, agitation, carbon dioxide concentration at one or more locations, carbon dioxide crushing, time, carbon dioxide flow rate, and the like; a system for determining carbonation level of carbonated aggregates and, optionally, other concrete components including final concrete; and a control system. In certain embodiments, a plurality of aggregate carbonation sites may be connected in a network, e.g., a network with a common controller. Additionally or alternatively, in certain embodiments, a plurality of concrete production sites are connected to a common aggregate carbonation site, e.g., with a common controller. In certain embodiments, a plurality of concrete production sites is connected to a plurality of aggregate carbonation sites, e.g., with a common controller. Thus, in certain embodiments, 2, 3, 4, 5, 6, 7, 8, 9, 10, or more than 10 aggregate carbonation sites may be networked, e.g., under a common controller; 2, 3, 4, 5, 6, 7, 8, 9, 10, or more than 10 recycled aggregate production sites may be networked/connected to a single carbonation site; and/or 2, 3, 4, 5, 6, 7, 8, 9, 10, or more than 10 concrete production sites using carbonated RCA may be networked, e.g., under a common controller. The controller, either a controller at a single site or a network controller, or both, may be configured to learn, e.g., through machine learning, from one or more batches and apply the information to other batches; this can be, e.g., information from a first batch or set of batches that is applied to a second batch or set of batches by modifying the conditions of the second batch according information obtained from the first batch or batches. The second batch may be a subsequent batch or batches at the same facility and/or a batch or batches at a different facility than the first batch or batches. Inputs for learning can include concrete age, degree of hydration, proportion of paste, particle size, and/or any other suitable characteristic, such as those described herein. The controller can perform one or more optimization algorithms using the input data and produce output; e.g. instructions for appropriately modifying carbonation or other processes.

Carbonation of recycled concrete aggregates may be done as a batch process, for example a batch process in a sealed system. An aggregate vessel for treatment may be any suitable vessel; a series of vessels may be used depending on the exact treatment sequence. In certain embodiments, one or more of the vessels is a vessel retrofitted from its usual use in aggregate transport, storage, and the like; suitable vessels for retrofit include rail cars, silos, truck/trailer, huts, or a combination thereof. The carbonation of the aggregates will depend on pressure, moisture, temperature, time, and any other suitable factors. Used or returned concrete is transported to the site, and either treated at the site or before transport to produce crushed aggregate of suitable size for treatment. In certain cases it is desirable to perform tests on the aggregate to be treated to determine suitable treatment conditions. The crushed aggregate may be sorted by size, e.g., by sieving, before, during, and/or after treatment. For example, size of the aggregate may determine treatment conditions and suitable sized aggregate may be used in a given treatment protocol. The appropriate aggregate is situated in a first treatment vessel.

Carbon dioxide may be applied to the recycled concrete aggregate in any suitable form, typically gaseous, and in any suitable manner. Typically, initially the carbon dioxide is pressurized to some degree to allow flow through the aggregate. At a suitable point, the pressure is transferred to atmospheric pressure. Pressure can be monitored, e.g., by one or more pressure sensors; pressure drop with time may be monitored and, in some cases, controlled, e.g., to determine when to pass to a subsequent step of the process. Carbon dioxide may be applied in any suitable manner in order to expose the aggregate to carbon dioxide; for example, carbon dioxide may be applied at the bottom of a treatment vessel, under the mass of material, and fill the vessel as it is applied. In this and other cases, it can be useful to monitor carbon dioxide concentration at one or more locations, e.g., at the top of the vessel and/or at leak points in the vessel if it is not airtight, to indicate when the vessel is full of carbon dioxide; as carbon dioxide is used in the carbonation process, additional carbon dioxide may be added, e.g., to top off the vessel. Other additions of carbon dioxide may be performed as required or desired in the process. Carbon dioxide addition may be halted when carbon dioxide concentration at or above the top of the aggregate in the vessel is such that it indicates complete addition of carbon dioxide. One or more agitation cycles may be used during the process to help with homogenization. In certain cases, the vessel may be treated, e.g., by application of a vacuum, to partially, completely, or substantially completely deplete it of air before the addition of carbon dioxide, allowing a more concentrated atmosphere of carbon dioxide to contact the aggregates. Without being bound by theory, it is thought that such a depletion may deplete some or all of the pores, making them more accessible to carbon dioxide.

Moisture (humidity) is generally an important factor in carbonation of recycled concrete aggregate, and typically process systems will monitor moisture in the process vessel and adjust to keep it in a desired range, e.g., an optimal range. To increase humidity, moisture may be added directly to the chamber. This can occur in any suitable manner; for example, moisture may be added during an agitation cycle, as part of a gas injection, or both. The amount of moisture to supply in a gas injection may be determined, e.g., based on the existing chamber humidity. To decrease moisture, any suitable method may be used, e.g., a desiccation loop to remove water from the system where moist gas is removed from the vessel, moved through the loop, and sent back to the vessel as drier gas. Different levels of humidity may be useful at different points in the process and thus humidity may be varied, continuously or in steps. Thus, humidity may be adjusted to a first value at a first time, a second value at a second time, etc., as appropriate for the process. The times for humidity change may be predetermined or may determined based on one or more characteristics of the process.

Temperature can also be an important factor in carbonation processes. The carbonation process is exothermic and the carbonation reaction causes the temperature to rise. If cooling is desired, it may be achieved in any suitable manner, such as an air loop with a heat exchanger (which may be the same loop as for humidity control or a different loop), and/or external cooling of the treatment vessel, and the like. Carbon dioxide has a higher solubility in water at lower temperatures, so it is generally desirable to control temperature rise; it may even be desirable to cool the reaction vessel below ambient temperature. Temperature can be controlled in a range to increase, e.g., maximize, uptake and/or reduce process time. In certain cases, as when unprocessed flue gas is used, for example, from a cement plant, a higher temperature may be used due to the high temperature of the flue gas; the flue gas may, in some cases, be cooled as appropriate for use in the system. Temperature in the system can be monitored with one or more sensors at suitable locations, such as on the interior and/or exterior surface of the vessel, in the gas mixture inside the vessel and/or in a gas loop exterior to the vessel, and the like. Temperature can also be used as an indicator of the extent and/or rate of the carbonation process.

Any suitable treatment logic may be used. In certain cases, one or more, or all, conditions are predetermined and the treatment runs on a set course. In general, however, it is useful to monitor one or more characteristics of the system and treatment and to adjust as desired to modulate the process to increase efficiency and/or uptake. For example, as described above, temperature and moisture may be monitored with appropriate sensors and one or both adjusted as appropriate. Carbon dioxide may be monitored. Carbon dioxide content at various locations in the system may be monitored as described above. Additionally or alternatively, gas flow input/output can be monitored, for example, using a gas loop that only moves pressurized air to allow for moisture and temperature control. Generally, carbon dioxide absorption is expected to be high at first and taper off with time. A controller receiving inputs as to carbon dioxide flow rate, pressure, and/or content can modify carbon dioxide input according to changes indicative of carbon dioxide absorption. E.g., the carbon dioxide content in gas phase/pressure of carbon dioxide as it changes with time may be monitored. The rate of change of gas concentration can be associated with reaction rate. Additionally or alternatively, heat release as indicated by temperature can be associated with uptake rate/reaction rate. A controller may use one or more of these characteristics to determine suitable changes in, e.g., gas flow rate, temperature, humidity, and/or other suitable factors. The process end point may be predetermined, or may by indicated by a change in reaction rate, e.g., a predetermined change in reaction rate. The process end point may be at any suitable time. In certain cases, the process endpoint is determined based on projected level of carbon dioxide uptake, e.g., at a projected level of 20-100% maximum, such as 50-100% maximum, or 80-100% maximum. It will sometimes be the case that a more efficient carbonation operation is achieved with an uptake below 100% maximum, such as less than 99, 98, 97, 95, 92, 90, 85, 80, 75, 70, 65, 60, 55, 50, 45, 40, 35, 30, 25, 20, 15, 10, or 5% of maximum.

Carbonation of RCA may be achieved in an open flow through system. Such a flow through system may include one or more of a rotating packed bed, and/or conveyor belt, which can provide residence time, with, e.g., carbon dioxide gas flowing up through the belt. Treatment logic can include parameters as described above.

Systems and processes for carbonation of RCA may be implemented in a number of different ways. For example, carbonation can occur at one or more of crushing and grading/classification of recycled concrete. Input can be returned or end of service life concrete and the output can be treated aggregates. Carbon dioxide can be applied during the crushing process, optionally with additional agitation, e.g, to open up fresh surfaces for carbonation. Additionally or alternatively, carbon dioxide can be applied before, during, and/or after classification of the crushed concrete. In certain cases, fractions of the crushed concrete, such as undersize fractions, can be cycled into the next stream. In certain cases different size fractions are treated differently. Carbonation operations, with or without crushing operations, may be performed in a modular unit; such a unit may be easily integrated into existing aggregate recycling operations. The carbonated aggregates may be used on site and/or transported to an appropriate facility for use, generally a concrete-producing facility or other suitable facility for use of recycled concrete aggregates.

### Quantification of Potential CO₂ Uptake of RCA

The amount of CO₂ an RCA is capable of sequestering will depend on various factors, such as particle size, age, previous carbonation, and the parent concrete mix design. Many researchers have looked at how these parameters affect the sequestering potential and younger, finer particles usually have higher potential for CO₂ uptake. Most research projects have focused on using concrete made in the laboratory where the mix design, curing, and age are known. However, if carbonation treatments of RCA for used in the field become practical it will be useful to evaluate RCA sources that may have combination of various parent concrete as well as of multiple age and previous carbonation. It is therefore useful to quantify how much CO₂ an RCA source can sequester and if treatments would be practical.

A protocol and test procedure have been developed to measure the potential of any RCA to sequester CO₂. A sample of the RCA, with the same grading curve as proposed for treatment, is placed in a sealed pressure vessel. The vessel is equipped with a pressure gauge to monitor any changes in pressure and its weight has been recorded. Prior to testing, the RCA cannot be oven dried nor can it be soaking wet. Moisture content can be anywhere from 1% to saturated. The maximum moisture content will depend on the aggregate, as the water absorption will be different. In preferred embodiments the aggregate should not be fully saturated, such as having a moisture content of 30-70% of maximum water absorption.

At the same time as the sample is placed in the vessel, another sample is used to determine the moisture content of the aggregate at the start of the test. Initial mass of the test sample in the vessel is determined. A known quantity of solid CO₂ is added to the vessel and the vessel is sealed. The mass of the sealed vessel is determined. As the CO₂ sublimates the pressure within the vessel will build up. The amount of CO₂ added should be small enough so that the pressure within the bottle will not exceed the capability of the vessel. The ideal gas law can be used to determine what amount is suitable. The amount of CO₂ added is determined and once the vessel is sealed the pressure is monitored.

In the first three days of testing, CO₂ is added to the vessel a plurality of times each day, e.g., at least two, preferably at least three times throughout a workday. If the gauge pressure within the vessel drops to 0 or below, more CO₂ should be added even though that would result in more than two or three additions of CO₂ in the vessel within a day. The weight of the vessel can be monitored while sealed to detect any leakage from the system. The weight of the vessel can also be monitored any time it is opened to add more CO₂ to monitor the mass change of the aggregate. After about 60 to 72 hours most aggregates have reached the maximum uptake. This is recognized by limited mass gain between CO₂ additions and how the efficiency of each CO₂ addition drops below 10%, as seen in FIG. 14 and Example 2. When this limit is reached the RCA is considered to have absorbed or sequestered as much CO₂ as it will do. Any remaining potential sequestration would be extremely slow and the amount can be considered negligible.

Once the final mass of the sample has been determined the RCA is extracted from the vessel and the final moisture content determined. The CO₂ uptake of the sample is then confirmed using any suitable method, e.g., the furnace testing procedure described elsewhere herein. As the maximum uptake of CO₂ will depend on the aggregate gradation, it is expected that coarsely graded aggregates could potentially absorb more CO₂ if they would be crushed further, even after going through this procedure. Therefore it is important that the aggregate's CO₂ uptake potential is evaluated using material with same gradation as will be used for treatment. This protocol can evaluate and comparing the potential uptake of any RCA source, regardless of age, previous carbonation, mix design, contamination etc.

### Aqueous Carbonation Systems and Methods

In certain embodiments, RCA is exposed to carbon dioxide dissolved in water. RCA can be treated to reduce its size, e.g., by crushing, in some cases combined with further treatment as described herein to further reduce size, such as exposure to steel spheres, etc., producing particles of the RCA. The particles can separated into one or more size ranges, as described herein, e.g., by sieving, then placed in an aqueous environment where it is exposed to carbonated water. This is distinct from methods in which a humidified atmosphere is used, in that the RCA is exposed to bulk water, either by immersion or by spraying and percolating, as described below. Carbonated water can be water that is exposed to carbon dioxide at a concentration greater than that for atmospheric carbon dioxide and into which carbon dioxide has dissolved and, generally, will contain one one or more of dissolved carbon dioxide, carbonic acid, bicarbonates, and/or carbonates; if the water contains divalent cations such as calcium or magnesium, a carbonate of the cation may be formed, as well.

The RCA can be unconfined or confined. Unconfined RCA generally is RCA that is not contained in a watertight or substantially watertight container, and can be as simple as a pile of RCA formed from transport of one or more loads of RCA to a site where the RCA is dumped and allowed to form a pile. Confined RCA is generally RCA that is contained in a watertight or substantially watertight container, e.g., a container that either does not leak when water is added or leaks at a rate that is sufficiently low that it does not significantly affect the process of carbonating the RCA.

In certain embodiments, RCA is unconfined, e.g., in one or more piles. This is especially suitable for treatment sites, such as quarries, that have limited resources available to use for confined systems. The pile or piles may be completely freestanding or may have sufficient structure around it to provide a desired shape for carbonation; so long as the structure is not watertight or substantially watertight it can be considered unconfined; generally such structure will not be so extensive as to completely enclose the RCA, e.g., a loose mesh or the like. RCA that has been treated to obtain a desired range of sizes is placed in a pile, and carbonated water is contacted with the surface of the pile via one or more water distribution systems in such a manner as to uniformly deliver carbonated water to most or all of the surface the pile, or to a portion of the surface of the pile that allows it to percolate through all or substantially all of the RCA in the pile. For example, one or more sprayers may be used at suitable locations to provide uniform coverage, such as at least 1, 2, 3, 4, 5, 6, 7, 8, 9, 10, 11, 12, 13, 14, 15, 16, 17, 18, 19, or 20 sprayers and/or not more than 2, 3, 4, 5, 6, 7, 8, 9, 10, 11, 12, 13, 14, 15, 16, 17, 18, 19, 20, 25, 30, or 40 sprayers, such as 3-10, in some embodiments 4-10, in other embodiments 5-15 sprayers. Any other mechanism for contacting carbonated water with the surface of the pile in such a way as to provide the desired coverage may be used, e.g., as simple as one or more conduits out of which carbonated water emerges, such as simply as a stream of water, or dispersed by, e.g., a sprinkler arrangement, such as a sprinkler that changes direction of the water emerging from it so as to move a stream of water across the surface of the pile. The pile may be any suitable size and shape, so long as it maintains integrity sufficient to allow a desired degree of uniform coverage, e.g., by the sprayer or sprayers. The carbonated water percolates through the pile and carbonates the RCA; in the process the water decreases in carbon dioxide content and increases in pH. The water exits the bottom of the pile and is collected, e.g., in a holding tank. A structure such as a permeable layer, as described herein, may be between the bottom of the pile and the holding tank to ensure that RCA does not substantially cross into the holding tank; movement of a small amount of RCA into the holding tank is acceptable so long as the amount is not such as to interfere or substantially interfere with further processes. The water in the holding tank is exposed to carbon dioxide to recarbonate the water and circulated back to the one or more sprayers. Exposure to carbon dioxide may occur in the tank itself. Additionally or alternatively, water may be pulled from the tank into a first conduit where it is exposed to carbon dioxide introduced into the conduit in any suitable manner. For example, a second conduit running from a source of carbon dioxide may join the first conduit and provide gaseous carbon dioxide to the water in the first conduit. Any suitable configuration for introducing the carbon dioxide may be used, and will be apparent to those of skill in the art. In certain embodiments carbon dioxide is contacted with the water via an inline injector, e.g., a conduit disposed within the conduit carrying the water. Exemplary apparatus/systems include one of the Solvocarb™ systems, available from Linde, or systems described in PCT Publication Nos. WO2018232507 and WO2021071980; any other suitable structure, as will be readily apparent to those of skill in the art, may be used. In general, carbon dioxide is introduced at or near the start of the first conduit and has sufficient time to completely dissolve in the water and/or react with components of the water so as to remove the gaseous carbon dioxide (e.g., no bubbles) by the time it reaches the sprayer or sprayers. Its pH will generally have decreased from the tank or other container into which the water percolates (highest pH) to the sprayer (lowest pH) as carbon dioxide dissolves and forms various products that increase acidity. As carbonation of the RCA progresses, the difference in pH between percolated water emerging from the bottom of the pile and re-carbonated water contacted with the surface of the pile decreases, because less carbon dioxide is removed in the carbonation process. The rate of delivery of carbon dioxide via the second conduit may be modulated, e.g., decreased, as the pH difference decreases. One signal to halt the spraying/carbonation can be that the difference in pH reaches a threshold value; at or below the threshold value the carbonation process is halted. This threshold difference can be any suitable difference, such as 4, 3.5, 3, 2.5, 2, 1.8, 1.5, 1.4, 1.3, 1.2, 1.1, 1.0, 0.9, 0.8, 0.7, 0.6, 0.5, 0.4, 0.3, 0.2, or 0.1 pH units. In certain embodiments the threshold difference is 2.0 pH units; in other embodiments the threshold difference is 1.0 pH unit; in yet other embodiments the threshold difference is 0.5 pH unit. It will be appreciated that complete carbonation may not be most efficient, and a pH difference may be chosen that correlates with less than complete carbonation, such as no more than 20, 30, 40, 50, 60, 70, 80, 90, or 95% complete carbonation. After carbonation has reached the desired endpoint, carbonated water is shut off and the carbonated RCA may be moved to a different location for storage until use. Additionally or alternatively, one or more of water temperature at one or more points, non-H+ ionic activity of water at one or more points, and/or time of treatment may be used to determine when and/or how much to regulate flow of water and/or carbon dioxide. In certain embodiments, flow of carbon dioxide and/or water is halted after a certain pre-determined time. The time may be determined by, e.g., based on the amount of carbonation expected for the RCA (which can be determined as described elsewhere herein), the rate of carbon dioxide delivery, the likely amount of carbonation to be achieved in the conduit at various points in the process, and/or other relevant characteristics.

In certain embodiments, a plurality of piles of RCA is used for carbonation, such as at least 2, 3, 4, 5, 6, 7, 8, 9, or 10 and/or not more than 3, 4, 5, 6, 7, 8, 9, 10, 12, 15, 20, or 50. In certain embodiments, 2-10 piles are used. The carbonation equipment can be moved from pile to pile. In certain embodiments, each pile has its own carbonation setup, with, e.g., sprayers and one or more conduits leading to the, e.g., sprayers to provide carbonated water. The water that percolates through a given pile may be collected, re-carbonated, and re-used for that same pile. In certain embodiments, water percolating through a plurality of piles, such as all the piles in a system, may be transported, e.g., via conduits, to a central collection vessel, then carbonated, in the vessel and/or in one or more conduits as described above, and distributed back to the individual piles. The water may be recirculated into the collection vessel via a recirculation loop as described above, where the loop continues to operate to maintain a desired level of carbonation of the water, and one or more separate conduits may be used to transport carbonated water from the vessel back to the piles. As with individual carbonation, when a pile has reached a desired degree of carbonation the RCA may be transported to another location for storage until use; one or more carbonated piles may be consolidated into a single storage pile. Transport may be by any method, e.g., a grader or other heavy machinery that has the capacity to remove material from a collection of material; it may then be moved by the same or different machinery to a new site (e.g., placed in a dump truck or similar to transport to the new site). When the RCA has been removed, the site is available for new RCA to be carbonated. In certain embodiments, after carbonation is complete a pile may be rinsed with, e.g., fresh water that does not contain chemicals (as described below) to remove some or all of any chemicals to which the RCA was exposed before or during the process.

In certain embodiments, RCA is confined in a suitable treatment vessel and carbonated in the vessel. Carbonated RCA can be removed from the vessel and a fresh batch of RCA introduced. A plurality of vessels may be used. The vessel may be any suitable vessel so long as it is watertight or substantially watertight, e.g., so that leakage, if it occurs, does not significantly affect the process, and is of sufficient strength to hold the RCA and water.

A treatment vessel can be any suitable vessel, e.g., a pond. A treatment vessel can be open to the atmosphere. A treatment vessel can be composed of any suitable material so long as it provides the requisite watertightness and strength, e.g., stainless steel or concrete. An empty treatment vessel, such as an empty pond, can be filled with untreated RCA, generally RCA with has been treated as described herein to produce a desired particle size or range of sizes (e.g., by crushing and sieving). The vessel can be filled with water, covering the RCA; typically it is desirable to completely cover the RCA. In certain embodiments, CO2 gas is introduced into the water, e.g., by injection into the pond, to use the water as an aqueous CO2 treatment solution. The CO2 gas can be injected in any suitable manner, e.g., through micro bubbler hoses, aeration hoses or similar arrangement. The hoses can be, e.g., placed at the bottom of the pond from where the CO2 rises into the solution through buoyancy. An enclosure on the top of the pond can serve to allow collection and recycling of gas that passes through the pond without reacting. The rate of gas delivery can be adjusted according to measurements of the solution such as ion concentration and/or pH. Measurement of such aspects can allow the gas portion to be controlled to match the ability of the solution and RCA to uptake the CO2 thereby improving the efficiency of the process.

Additionally or alternatively, carbon dioxide may be introduced into the water in an external circulation loop, such as a loop described in PCT Publication Nos. WO2018232507 and WO2021071980 and more fully herein. In certain embodiments the pond can comprise clarified wash water, e.g., wash water that has been carbonated then clarified, as described in PCT Publication Nos. WO2018232507 and WO2021071980 and more fully herein.

In certain embodiments, water is removed from a treatment vessel after passing through most or all of the RCA, e.g., at one or more locations near the bottom of the RCA, exposed to carbon dioxide to recarbonate the water, then re-introduced to the vessel, typically at or near the surface of the water in the vessel, and in a manner to provide a desired degree of uniform coverage of carbonated water to the RCA. The vessel can contain an arrangement of one or more permeable layers and one or more impermeable layers to allow water, but not RCA (or not a significant amount of RCA) to flow across the permeable layer to collection pool. The permeable layer may be any suitable material so long as it allows water but not the RCA through, or not more than an acceptable level of RCA through, such as a fine mesh, e.g., metal mesh, or an arrangement of a plurality of blocks, such as concrete blocks, and the like. In certain embodiments the permeable layer is a mesh, such as a wire mesh, of sufficient fineness that RCA of the size range in the vessel does not cross, or does not cross in an amount to significantly affect the rest of the process. It is desirable that the permeable layer be situated so that water passing through it has already passed through most or all of the RCA. The permeable layer and impermeable layer can be arranged so that the permeable layer is below the impermeable layer and only rises up sufficiently from the base of the RCA to allow a suitable flow to the collection pool, e.g., extends from the base of the container to a height that is less than 10, 15, 20, 25, 30, 40, or 50% the average height of the RCA in the container; in certain embodiments, less than 25% and in preferred embodiments less than 15%. Because water is being removed at one point that is low in the container and reintroduced at another that is at or near the surface of water in the container, flow through the RCA is established and maintained. In certain embodiments water can be removed from the vessel into a conduit in which carbon dioxide is introduced into the water at the start of the conduit, at a position and rate that, combined with the rate of movement of water through the conduit, the carbon dioxide can dissolve in the water, partially or, preferably, completely, then reintroduced at or near the surface of water in the vessel. The rate of carbon dioxide flow, rate of flow of water into and through conduit, and/or length of conduit may be calibrated or adjusted so that all or substantially all of the gaseous carbon dioxide, such as at least 80%, in some cases at least 95%, preferably at least 99% and most preferably, 100%, is dissolved in the water before it is discharged at a sprayer. However, as carbonation of the RCA proceeds it may no longer be possible to dissolve 100% of the carbon dioxide before it reaches a sprayer. The carbonated water may be distributed by one or more distributers onto or near the surface of the water, e.g., sprayed via one or more sprayers at one or more points onto the surface of the water. It may simply emerge from the end of one or more conduits, even without spraying, at one or more locations at the surface or even below the surface. Other arrangements and equipment will be readily apparent to one of ordinary skill in the art. It is preferable that the reintroduction of the carbonated water is performed in a manner as to distribute the carbonated water relatively evenly in the vessel and/or movement of water in the vessel is such that carbonated water is distributed relatively evenly. In general, input and output of the system is configured to achieve a desired level of uniformity of contact of carbonated water with RCA. Water can be sampled at various places in the vessel and tested to determine if distribution is at the desired level of uniformity; if it is not, components and/or component configurations may be altered until the desired level is reached. The system may be controlled by a controller, where the controller receives information regarding one or more characteristics of the system, processes the one or more characteristics, determines whether or not and/or how much to modulate flow of water and/or carbon dioxide, and sends an output, if necessary, to one or more actuators, e.g., one or more valves, to implement the modulation, if such is determined. The one or more characteristics can include pH of water at one or more points (e.g., pH of pool (percolated) water, pH re-carbonated water before it is contacted with RCA, and the like); water temperature at one or more points (e.g., pool (percolated) water, re-carbonated water before it is contacted with RCA, and the like); non-H+ ion activity at one or more points (e.g, pool (percolated) water, re-carbonated water before it is contacted with RCA, and the like); and/or time of treatment. In certain embodiments, flow of water and carbon dioxide start and continue for a predetermined time, at which point they are halted. The removed water (which can in some cases include water used to wash the carbonated RCA) may be used in any suitable manner, e.g., discharged, moved to a storage vessel then reused in another batch of RCA, reused in a concrete plant as at least a portion of mix water, and/or reused to wash out trucks. In some cases the carbonated RCA can be washed to remove water remaining from the treatment step. For example, if one or more additives were used in the RCA carbonation procedure (e.g., see below), additive-free water can be applied to the carbonated RCA until a desired point is reached, e.g., for a certain time, a certain volume, and/or until a concentration of one or more additives in the outgoing water is below a certain concentration or concentrations of the one or more additives. The treated RCA is then removed from the vessel, using any suitable method. In certain cases a piece of heavy equipment, such as suitable earth moving equipment or the like as known in the art, may be used to remove RCA from the vessel; in certain embodiments, such as the third embodiment below, the earth mover is driven down a ramp that is part of the containment vessel, picks up a load of RCA, and is driven out of the vessel; the same equipment, or different equipment, such as a dump truck or similar equipment, a series of, e.g., railway cars, or conveyer belt or the like, may be used to move the treated RCA to another site, where it is stored until use.

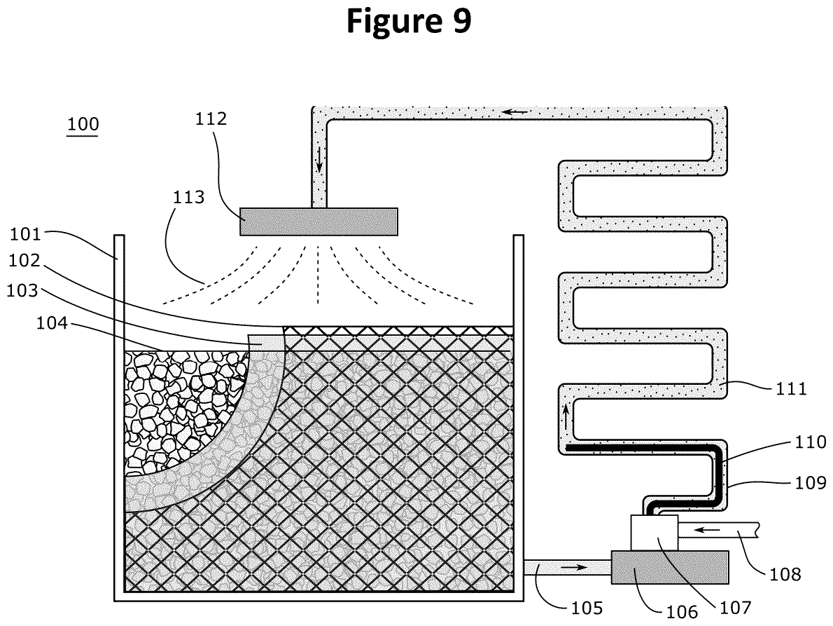

In a first exemplary embodiment 100 (FIG. 9) RCA 104, crushed and graded as desired, is situated in a watertight or substantially watertight vessel 101, immersed in water 103 with a permeable layer 102. A permeable layer is shown in FIG. 9 to surround the RCA but any suitable configuration may be used, e.g., permeable layer and impermeable layer as described above. Water passes through the permeable layer into a pool of separated water. A conduit 105 leads water away from the pool of separated water when a pump 106 is engaged. At a CO2 junction 107, gaseous carbon dioxide supplied from a CO2 supply (not shown) by a CO2 gas injection conduit 108 is introduced into the water, e.g., through a gas diffusion hose or similar apparatus 109, which fits inside a conduit 110 through which the water flows. Water flows through the conduit and is discharged at a large sprayer 112, which sprays the carbonated water 113 back onto the top of the water in the tank in such a manner that the carbonated water is sufficiently evenly distributed over the surface of the water in the tank that flow of the water will expose most or all of the RCA to the carbonated water. Suitable control, as described above, is used to modulate flow of water/carbon dioxide, and carbonated RCA is removed from the vessel.

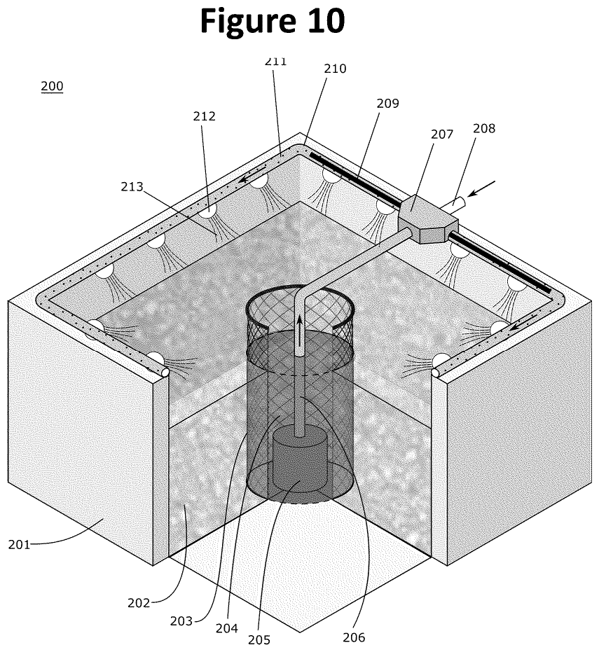

In a second exemplary embodiment 200 (FIG. 10) a vessel 201 contains RCA, crushed and graded as desired, in water 202. A radial permeable layer 203 at the interior of the vessel serves to separate water 204 from the RCA to create a pool of separated water. A radial permeable layer that goes from bottom to above water level, as shown in FIG. 10, may be used. Preferably, a radial permeable layer is used that only allows water from the bottom of the RCA (where most of RCA has been exposed to carbonated water) is used, and the rest of the layer is formed from impermeable material. For example, the radial layer may be formed of impermeable material starting above water level and until it reaches a level of less than 5, 10, 15, 20, 25, 30, 40, 50, or 60% of the average height of the RCA layer, such as less than 30%, in some cases less than 20%, in certain cases less than 15% and even less than 10%, of the average height of the RCA layer, where it is formed of permeable material. A pump 205, when engaged, pumps water from the pool of separated water into a conduit 206 and to a CO2 junction 207 where gaseous CO2 supplied from a CO2 supply (not shown) by a CO2 gas injection conduit 208 is introduced into a gas diffusion hose 209, from which it is introduced into the water in a perimeter conduit 210. The gas diffusion hose may have any suitable configuration to introduce carbon dioxide into the water as described herein. The perimeter conduit 210 runs around the perimeter of the upper part of the container 201, above the level of the water. The treated (carbonated) water 213 is sprayed or otherwise introduced at suitable intervals through a plurality of sprayers or like equipment 212, onto the surface of the water. The number, spacing, and/or spraying configuration of the plurality of sprayers can be chosen to provide a uniform distribution of the carbonated water onto the surface of the water in the vessel. Control mechanisms can be as for the first embodiment. Carbonated RCA is removed and placed at a storage location and new RCA may be introduced.

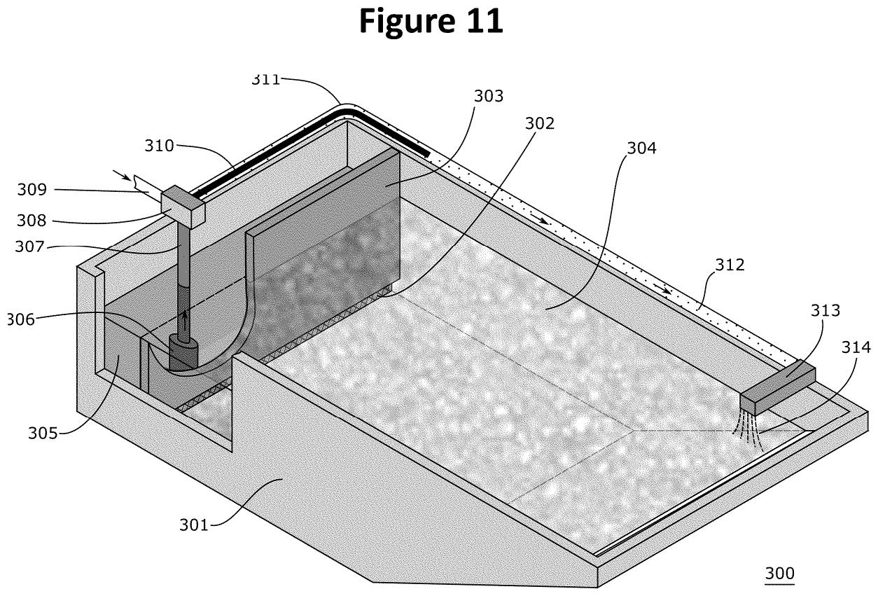

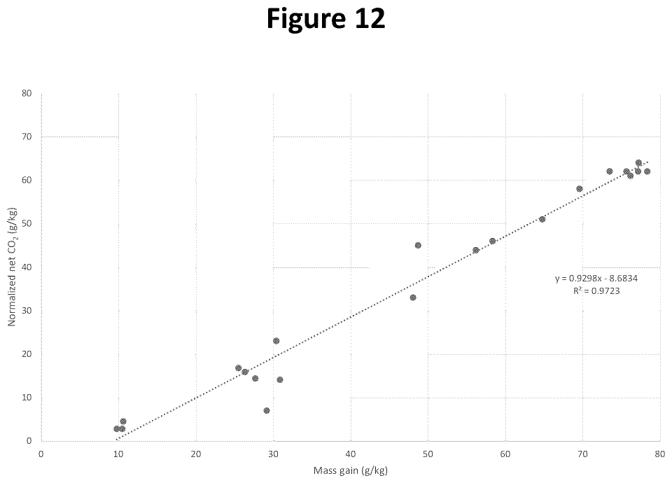

A third exemplary embodiment (FIG. 11) comprises a vessel 301 having at one end a sloped surface, e.g., a sloped surface that will allow RCA-moving equipment, such as equipment described herein, to deposit and remove RCA at appropriate times, and at the other a containment layer comprising a lower permeable layer 302 and an upper impermeable layer 303 that separate RCA 304, crushed and graded as desired, from water 305 with no RCA or little RCA in a pool of separated water. Permeable layers can be as discussed, e.g., a mesh, or a set of concrete blocks, or any other suitable material and arrangement, so long as the amount of RCA that escapes the containment vessel is not enough to significantly affect the rest of the process. It is desirable that the permeable layer be of a height that water passing through it has already percolated through most of the RCA; for example, the containment layer may be formed of impermeable material starting above water level and until it reaches a level of less than 5, 10, 15, 20, 25, 30, 40, 50, or 60% of the average height of the RCA layer at the end where the containment layer is situated, such as less than 30%, in some cases less than 20%, in certain cases less than 15% and even less than 10%, where it is formed of permeable material. A pump 306, when engaged, pumps water from the pool of separated water into a conduit 307 to a CO2 junction 308 where gaseous CO2 supplied from a CO2 supply (not shown) by a CO2 gas injection conduit 309 is introduced into a gas diffusion hose 310, from which it is introduced into the water in a perimeter conduit 311. The gas diffusion hose may have any suitable configuration to introduce carbon dioxide into the water, e.g., a plurality of perforations along its length, or other configuration, as discussed herein. The perimeter conduit 311 runs around the perimeter of the upper part of the containment vessel 301 to a sprayer or other suitable equipment 313, situated at or near the opposite end of the containment vessel from the pump, which sprays or otherwise distributes carbonated water 314 onto the surface of the water in the containment vessel 301. More than one sprayer may be used, if desired or needed to reach a desired uniformity of distribution of the carbonated water; water may be sampled at various places with a given configuration of sprayer and the number and/of configuration of sprayers can be adjusted, if necessary, to achieve a desired uniformity. The rate of carbon dioxide flow into the CO2 junction 308, rate of flow of water into and through perimeter conduit 311, and/or length of perimeter conduit 311 may be calibrated or adjusted so that all or substantially all of the gaseous carbon dioxide, such as at least 80%, in some cases at least 95%, preferably at least 99% and most preferably, 100%, is dissolved in the water before it reaches the sprayer 313. Control mechanisms can be as for the first embodiment. When carbonation is complete, water can be removed from the vessel, the RCA is optionally rinsed, and treated RCA removed from the vessel, all as described herein. In certain embodiments, a pond already on site that is used to hold, e.g., wash water that has been treated sufficiently to be clarified, may be retrofitted with the materials to convert one end to the configuration of the third embodiment (e.g., impermeable/permeable layer, pump, loop, sprayers, etc.) and used intermittently to carbonate RCA; e.g., on weekdays the pond is used for clarified wash water and on weekends RCA is introduced and carbonated, or other suitable arrangement. In certain embodiments, a plurality of systems of the configuration of the third embodiment is used; water from each may be moved to a single separate treatment vessel as described in the next paragraph.

In certain cases of the above embodiments, for example, the third embodiment, water that has passed through the permeable layer may be moved from the pool of separated water to a separate treatment vessel, where it is held and/or carbonated. This can be useful, e.g., when there is not enough time in a first pass to fully carbonate the water, or carbonate it to a desired level. Carbonation may be by any suitable system, such as the recirculation loop described in the first through third embodiments (thus, water is not carbonated in the treatment vessel but in the recirculation loop). The water may be monitored, e.g., for pH and/or other appropriate characteristics, and conditions manipulated as appropriate, to maintain the water at a desired level of carbonation. Water from the treatment vessel is returned to a containment vessel and distributed as described for each embodiment. Such a treatment vessel may also be used for other water, e.g., other process water at a facility that requires treatment, e.g., to lower pH, before discharge or other use.

### Chemical Additions in Aqueous Carbonation Systems

In certain embodiments, one or more chemical additions can be made to the pond or other treatment vessel and/or to RCA before it is introduced into the pond or other vessel. Various combinations of one or more of the following embodiments may be used.

In certain embodiments, one or more chemicals to promote dissolution of Ca and/or Mg components can be added. Various additives, are appropriate including strong acids (e.g., HCl, HNO3, and H2SO4), organic acids (e.g., acetic acid, formic acid, succinic acid, oxalic acid, etc.), and/or salts (e.g., NaCl, NH4Cl, trisodium citrate, disodium EDTA, sodium oxalate, sodium). In certain embodiments the chemical to promote dissolution comprises an organic acid. In certain embodiments the one or more chemicals to promote dissolution comprises a strong acid, e.g., HCl, HNO3, H2SO4, or a combination thereof. In certain embodiments the one or more chemicals to promote dissolution comprises HCl. In certain embodiments the one or more chemicals to promote dissolution comprises HNO3. In certain embodiments the one or more chemicals to promote dissolution comprises H2SO4. Dissolution enhancing chemicals can be added to the RCA before it is immersed in water, e.g., if a higher concentration of acid is desirable. Additionally or alternatively, the chemicals can be added to the water after the RCA is immersed. The amounts and addition rates of the chemicals can be controlled in response to properties of the solution and the treatment such as calcium ion concentration, temperature, and/or pH.

In certain embodiments, one or more surfactants is added to disperse carbonates. Mineralization reactions and/or performance of the wash water as used in concrete can benefit from the action of an appropriate surfactant. Suitable surfactants include, but are not limited to, Polycarboxylate ether-based superplasticizer (PCE), sodium salt of poly(acrylic) acid (PAANa), Sodium Dodecyl Sulfate (SDS), Triton X-405 (70% Active Octylphenol Ethoxylate in water), and/or Tween 80 (≥58.0% Oleic acid, balance primarily linoleic, palmitic, and stearic acids. In certain embodiments the one or more surfactants comprise Polycarboxylate ether-based superplasticizer (PCE), sodium salt of poly(acrylic) acid (PAANa), Sodium Dodecyl Sulfate (SDS), or a combination thereof. In certain embodiments the one or more surfactants comprises Polycarboxylate ether-based superplasticizer (PCE). In certain embodiments the one or more surfactants comprises sodium salt of poly(acrylic) acid (PAANa). In certain embodiments the one or more surfactants comprises Sodium Dodecyl Sulfate (SDS).

In place of a pond processing/treatment vessel can be used as an aqueous reactor.

### Carbonation of Wet Concrete Mixes

In certain embodiments, a wet concrete mix, such as a concrete mix mixed at a concrete batching facility but not used, is carbonated, allowed to set and harden, then comminuted to a desired range of sizes and used as aggregate in subsequent batches. It is understood that this is not wet concrete that will be used at a job site, that is, the wet concrete is generally concrete that has been returned as extra, or otherwise unused. Such concrete may already have been initially carbonated, e.g., by methods such as described in U.S. Pat. No. 9,738,562, or it may be uncarbonated.

Excess concrete is returned to a concrete plant from a job site. The concrete is often discharged from the truck so that the truck may be empty and accept a new batch of concrete. The management of the returned concrete can be a challenge. In current practices, the concrete can be used to make commodity precast components such as concrete blocks, or the concrete can be spread on the ground to harden before it is broken up and placed in a scrap pile (waste) or processed into small enough size fractions to be used as an aggregate (and placed in an aggregate stockpile).

In certain embodiments, the returned concrete is treated with CO2 to carbonate the mix, then spread out in a layer and allowed to set and harden, then comminuted to a desired size range and stored for use as aggregate in subsequent batches. The time allowed for setting and hardening can be any suitable time, so long as the hardened concrete has sufficient integrity to be broken into, e.g., coarse material; this time can be as short as one day. The coarse broken pieces can be moved to a storage site, where they are allowed to harden for an additional period, such as at least one week, at least two weeks, at least three weeks, or at least four weeks, then crushed and sized for use as aggregate.

Discharge Returned Concrete into a Processing Vessel

A supply of returned concrete can be transported in a container to a treatment system. Transport of the returned concrete can be in a concrete truck that is returning from a job or otherwise collecting excess fresh concrete. The concrete can be delivered to a processing vessel. The processing vessel prepares the concrete for CO2 treatment. In certain embodiments, the drum of the truck may itself be used as a processing vessel and concrete carbonated in the truck itself, then discharged to harden. In other embodiments, concrete is transferred to one or more separate processing vessels.

It is desirable to know the characteristics of a particular returned batch, e.g., the type and amount of cement, sand, coarse aggregates, etc. The batch design for any particular truck is known, and any suitable method can be used to communicate the desired information to, e.g., a control system that sets up and monitors a carbonation system.

In certain embodiments, the batch details may be communicated from the truck to the processing vessel or control system for a processing vessel (e.g., wireless communication, bluetooth, RFID, or similar). In this case, the truck can be aware of the mix design and/or batch actuals of the concrete it contains. The truck can communicate the information to the processing vessel or a controller operably connected to the processing vessel. The mass of the concrete input into the processing vessel can be measured, e.g., either as a mass increase of the vessel or a mass decrease of the truck. The mix information communicated by the truck to the vessel or controller can be used to determine the composition of the material in the vessel (e.g. the amount of cement, aggregate sand/or other components).

Communication of the returned concrete details to the processing setup can occur as soon as the concrete truck completes operations at the job site and a quantity of excess concrete is identified. Advance communication of the returned concrete can allow the treatment process to be scheduled or optimized. An example of this would be to instigate a reset process within a calculated timeframe so that a treatment setup engaged in a treatment process can complete the process and be an empty or ready process when the returned concrete arrives.

The mass of concrete can be measured, e.g., either as a reduction in mass of the truck or an increase in mass of the processing vessel. The processing vessel may measure the volume of the concrete. The processing vessel may measure the workability of the concrete.

The emptied truck can further be washed with the wash water directed to the main processing vessel or to a dedicated, and possibly integrated, wash water handling vessel. In certain embodiments, some or all of the wash water is itself carbonated and used in subsequent batches of concrete; see, e.g., PCT Publication Nos. WO2018232507 and WO2021071980. The concrete can be processed to separate the coarse materials (aggregates) from the paste phase. One example is sieving. The paste phase can be directed to a dedicated and possibly integrated, wash water handling vessel.

The processing vessel can be sized to accept partial loads of concrete. If a ready-mix truck contains up to 10 yd³ concrete when full then the processing vessel may be an equivalent size. Alternatively it may be a fraction of the size, such as 9, 8, 7, 6, 5, 4, 3, or 2 yd³, in certain embodiments 6 yd³; in certain embodiments 4 yd³; in certain embodiments 3yd³. The procedure can be designed such that the initial processing of the returned concrete is complete within a time frame suitable for being emptied before the next quantity of returned concrete is accepted.

In certain embodiments, the processing vessel is the drum of the ready-mix truck itself: additive, if desired, may be added to the concrete (see below) and carbon dioxide delivered to the drum with mixing, then the carbonated concrete discharged from the drum.

The processing vessel may alternatively be larger than a load of concrete and collect more than one returned load, for example, over the course of one hour to one day, before starting a treatment process. If multiple loads are collected a treatment process can be started as corresponding to each addition of returned concrete. Alternatively, one or more hydration stabilizing admixtures may be used to maintain the concrete in a fluid state until such time as the processing and treatment may start. Suitable hydration stabilizing admixtures include one or more of those disclosed in U.S. Patent Application Publication No. 20100139523.

In certain embodiments a buffer vessel may accept returned concrete and hold it if the processing vessel is engaged. The buffer vessel may add the concrete to the processing vessel when the processing vessel is able to accept returned concrete. Additionally or alternatively, multiple processing vessels can operate in parallel, e.g., to match the throughput of returned concrete. In such cases a buffer vessel may not be used, or used when throughput exceeds capacity of the available processing vessels.

The processing vessel can effectively agitate the concrete to permit mixing of one or more additions to the concrete. The processing vessel can be a concrete mixer designed to accept returned concrete, such as the mixing drum of a ready mixed truck. The processing vessel can be equivalent to a concrete mixer such as the type used in wet batch or central batch concrete production. The processing vessel can be designed with an internal screw (either to mix or to discharge the concrete from the vessel, as depending on the direction of rotation); this type of processing vessel, if also used as a treatment vessel, can allow high levels of carbonation that produce a very stiff concrete because the concrete can be forced out of the vessel. The processing vessel can omit directional movement of the contents and have an internal design suitable for rolling and expel contents through tilting.

At the time of processing, water may be added to wash the aggregates to create nominally clean aggregates that may be reintroduced to a stockpile of clean, virgin aggregate at the concrete producer location. Water may be added to a separated paste phase to achieve a target specific gravity, e.g. if paste phase is too thick, added water may dilute to become a slurry to, e.g., be treated as a wash water slurry.

For purposes of efficient throughput, the processing vessel can accept the returned concrete and add/intermix any enabling additions. At such time as the concrete has reached an appropriate condition for treatment, the material can be moved from the processing vessel to a separate treatment vessel where a CO2 mineralization step is conducted. An alternative to a separate treatment vessel is a single vessel that can serve both the processing and treatment functions.

### Treatment

The concrete is treated with carbon dioxide; any suitable dose of carbon dioxide may be used, such as not more than 5.0%, 4.0%, 3.5%, 3.0%, 2.5%, 2.0%, 1.5%, 1.2%, 1%, 0.8%, 0.7%, 0.6%, 0.5%, 0.4%, 0.3%, 0.2%, 0.1%, or 0.05% bwc and/or at least 0.01, 0.05, 0.1, 0.2, 0.3, 0.4, 0.5, 0.6, 0.7, 0.8, 0.9, 1.0, 1.2%, 1.5%, 2.0%, 2.5%, 3.0%, 3.5%, or 4% by weight cement (bwc), such as a dose of 0.01-5%, 0.01-4%, 0.01-3%, 0.01-2%, 0.01-1.5%, 0.01-1.2%, 0.01-1%, 0.01-0.8%, 0.01-0.6%, 0.01-0.5%, 0.01-0.4%, 0.01-0.3%, 0.01-0.2%, or 0.01-0.1% bwc, or a dose of 0.02-5%, 0.02-4%, 0.02-3%, 0.02-2%, 0.02-1.5%, 0.02-1.2%, 0.02-1%, 0.02-0.8%, 0.02-0.6%, 0.02-0.5%, 0.02-0.4%, 0.02-0.3%, 0.02-0.2%, or 0.02-0.1% bwc, or a dose of 0.04-5%, 0.04-4%, 0.04-3%, 0.04-2%, 0.04-1.5%, 0.04-1.2%, 0.04-1%, 0.04-0.8%, 0.04-0.6%, 0.04-0.5%, 0.04-0.4%, 0.04-0.3%, 0.04-0.2%, or 0.04-0.1% bwc, or a dose of 0.06-5%, 0.06-4%, 0.06-3%, 0.06-2%, 0.06-1.5%, 0.06-1.2%, 0.06-1%, 0.06-0.8%, 0.06-0.6%, 0.06-0.5%, 0.06-0.4%, 0.06-0.3%, 0.06-0.2%, or 0.06-0.1% bwc, or a dose of 0.1-5%, 0.1-4%, 0.1-3%, 0.1-2%, 0.1-1.5%, 0.1-1.2%, 0.1-1%, 0.1-0.8%, 0.1-0.6%, 0.1-0.5%, 0.1-0.4%, 0.1-0.3%, or 0.1-0.2% bwc, or a dose of 0.5-5%, 0.5-4%, 0.5-3%, 0.5-2%, 0.5-1.5%, 0.5-1.2%, 0.5-1%, 0.5-0.8%, or 0.5-0.6%, bwc, or a dose of 1-5%, 1-4%, 1-3%, 1-2%, or 1-1.5% bwc, or a dose of 2-5%, 2-4%, or 2-3% bwc, or a In general, it is desirable to use a dose that allows maximum carbonation while still allowing the wet concrete mix to retain sufficient workability for the remaining steps in the process. Thus, in a preferred embodiment, the dose is 0.5-5%; in an even more preferred embodiment the dose is 1.0-5%, or even 2.0-5% bwc. Any suitable form of carbon dioxide may be used, such as gaseous carbon dioxide or a mixture of gaseous and solid carbon dioxide, e.g., a mixture created by movement of liquid carbon dioxide provided from a source of carbon dioxide through an orifice, where it reaches atmospheric pressure and converts to solid and gaseous carbon dioxide; see, e.g., U.S. Pat. Nos. 9,738,562; 9,376,345; and PCT Publication No. WO2020124054 for details. In certain embodiments, a relatively high dose of carbon dioxide may be used, e.g., a dose that significantly decreases the workability of the concrete but not so high as to render the concrete completely unworkable. The treated concrete need merely be sufficiently workable that it can be removed from the treatment vessel; in the case of a treatment vessel with a screw assembly, the treated concrete can be forced out of the vessel and need only be workable enough to be forced out. The exact dose may be determined by, e.g., knowledge of the type and amount of cement in the concrete to be treated. Additionally or alternatively, the exact dose may be determined based on performance of previous batches during carbonation. Doses may be modified based on the strength of the carbonated concrete after it has set and hardened, e.g., so that a certain compressive strength is maintained (e.g., to reduce formation of fines when hardened concrete is crushed). In certain embodiments, one or more chemicals is added to the concrete to improve workability and allow the use of higher doses. Exemplary chemicals include one or more set retarders, such as one or more of carbohydrates, i.e., saccharides, such as sugars, e.g., fructose, glucose, and sucrose, and sugar acids/bases and their salts, such as sodium gluconate and sodium glucoheptonate; phosphonates, such as nitrilotri(methylphosphonic acid), 2-phosphonobutane-1,2,4-tricarboxylic acid; and chelating agents, such as EDTA, Citric Acid, and nitrilotriacetic acid. Other saccharides and saccharide-containing admixes include molasses and corn syrup. In certain embodiments, the admixture is sodium gluconate.

In certain embodiments, CO2 treatment of the returned concrete can include the addition of one or more chemicals to the concrete to convert it to a desired state for the treatment to occur such as moisture condition, particle size, carbonate polymorph control, etc.

In certain embodiments, on or more chemicals that promote granulation, such as super absorbent polymers, may be added. Non-limiting examples include natural polymers, such as Cellulose, Chitosan, and/or Collagen; Neutral Super Absorbent Polymers, such as Poly(hydroxyethylmethacrylate) (PHEMA), Poly(ethylene glycol) (PEG), Poly(ethylene oxide) (PEO), Polyacrylic acid (PAA); and/or Ionics Super Absorbent Polymers such as Polymethacrylic acid (PMMA), Polyacrylamide (PAM), Polylactic acid (PLA). In certain embodiments the one or more chemicals comprise an Ionic Super Absorbent Polymer, a Neutral Super Absorbent Polymer, a natural polymer, or a combination thereof. In certain embodiments the one or more chemicals comprise an Ionic Super Absorbent Polymer. In certain embodiments, the one or more chemicals comprise a Neutral Super Absorbent Polymer. In certain embodiments, the one or more chemicals comprise a natural polymer.

Additionally or alternatively, one or more chemicals that affect carbonation mineralization, e.g., by affecting calcium carbonate formation and/or morphology may be added. Non-limiting examples include Poly acrylic acid (PAA), Ethylenediaminetetraacetic acid (EDTA), Zinc chloride (ZnCl) Magnesium chloride (Mgcl2), Citrate and malate, Phthalic acid, Sodium dodecyl sulfate (SDS), Dodecyltrimethylamonium bromide (DDTAB), Poly (N-vinyl-2-pyrrolidone) PVP, Ammonium citrate, Polydiallyldimethylammonium chloride (PDDA), Cetyl trimethylammonium bromide (CTAB), Ethylenediaminetetraacetic acid (EDTA), Carboxymethyl chitosan (CMCS), Dodecyl sulfonate (DDS), Sodium dodecyl benzenesulfonate (SDBS)), Non-ionic dextran, Poly (N-vinyl-1-pyrrolidone) (PVP), Glycerol, Isopropyl alcohol and/or n-butanol Polyacrylamide (PAAM). In certain embodiments the one or more chemicals comprises PAA, EDTA, ZnCl, or a combination thereof. In certain embodiments the one or more chemicals comprises PAA. In certain embodiments the one or more chemicals comprises EDTA. In certain embodiments the one or more chemicals comprises ZnCl.

Additionally or alternatively, one or more surfactant chemicals may be added. Suitable surfactants include, but are not limited to, Polycarboxylate ether-based superplasticizer (PCE), sodium salt of poly(acrylic) acid (PAANa), Sodium Dodecyl Sulfate (SDS), Triton X-405 (70% Active Octylphenol Ethoxylate in water), and/or Tween 80 (≥58.0% Oleic acid, balance primarily linoleic, palmitic, and stearic acids. In certain embodiments the one or more surfactant chemicals comprise PCE, PAANa, SDS, or a combination thereof. In certain embodiments the one or more surfactant chemicals comprise PCE. In certain embodiments the one or more surfactant chemicals comprise PAANa. In certain embodiments the one or more surfactant chemicals comprise SDS.

The carbon dioxide treatment can involve CO2 supplied in a solid and/or gaseous form. The CO2 can come from any suitable source. In certain embodiments, carbon dioxide is provided from a direct air capture system. In certain embodiments, carbon dioxide is provided from a concrete plant operation that produces CO2. In certain embodiments CO2 is provided from an operation wherein organic matter is converted by anaerobic fermentation to methane and carbon dioxide, e.g., a biogas operation.

In certain embodiments some or all of the carbon dioxide can be supplied as part of a solution containing a solute that contains carbonate or bicarbonate ions. Soluble carbonates in solid form could be added to the concrete and enter into the solution phase of the concrete. Soluble carbonates can be provided with a time-release aspect through preparation in the form of dissolvable pellets, or the active ingredient encased in a soluble shell, or a soluble packaging containing the soluble active solid. Examples of suitable soluble carbonates include but are not limited to Na2CO3—Sodium Carbonate; NaHCO₃—Sodium Bicarbonate; KHCO3—Potassium Bicarbonate; Soluble crystalline ammonium carbonate—(NH4)2CO3; Lithium carbonate—Li2CO3; Rubidium Carbonate—Rb2CO3; Cesium Carbonate—Cs2CO3, or a combination thereof.

In certain embodiments, some or all of the carbon dioxide may be supplied as carboxylates, e.g., carboxylates from oxalic acid, tartaric acid, citric acid, and/or gluconic acid.

A dose of carbon dioxide can be provided with knowledge of the contents of the treatment vessel, e.g. as described above. If the carbon mineralization reaction is dependent upon the available calcium and the cement content of the contained concrete is known then the amount of CO2 required to achieve a targeted uptake can be supplied. If the reaction rate and the total amount of calcium available is known then the rate of CO2 delivery can be determined. The amount of available calcium may be less than the stoichiometric amount of calcium. The amount of available calcium may be influenced by additions during the processing step.

The treatment vessel may be pressurized to promote faster CO2 mineralization.

The feed of CO2 and/or carbon-fixing chemical can be metered and monitored, using any suitable method; for example, see U.S. Pat. No. 9,376,345. The quantification of the feed amount can be converted into a quantity of mineralized CO2 through application of a mineralization efficiency factor (see Evaluation of Carbonation, below). Additionally or alternatively, actual carbonation may be determined for a final product, e.g., aggregates, by any suitable method, such as one of the methods described herein (see Evaluation of Carbonation, below). The net converted CO2 can be reported to a centralized ledger, e.g., for purposes of quantifying, verifying and/or commodifying CO2 reductions.

The treated concrete can be removed from the processing vessel and placed in a stockpile. An integrated system can transport the material from the processing vessel to a stockpile by means of a screw or conveyor belt or other suitable conveyance mechanism.

The processing and treatment vessel or vessels can take a mobile and/or modular format

### Formation and Treatment of Finer RCA

Recycled concrete aggregate can be made from hardened and crushed concrete. In one case the concrete can be −24 hour old returned concrete that has been spread in a thin layer to harden and then crushed, such as by heavy equipment driving over it. The material can be crushed further, graded and stockpiled. In another case the concrete is from a demolished structure. It has been separated from the other construction materials (e.g. wood, glass, steel) and is collected, crushed, graded and stockpiled. Other cases involve concrete of intermediate age.

Processing (crushing and grading) of recycled concrete, particularly such that is less than 28 days of age and of relatively lower strength than a fully mature concrete, for example, can create a significant fraction of fines as the softer paste phase is abraded due to particle-particle or particle-machinery interactions. The processing of the recycled concrete can be conducted to extract increased amounts of fines. Any suitable method may be used. An example is introduction of steel balls or other hard media, such as in a grinding mill, to promote the removal and pulverisation of the attached mortar/paste phase. A sieving step can be used to separate the grinding/milling media and coarser fraction from the desired fine fraction. The fine fraction can be preferentially separated from the concrete for additional treatment or processing. The fine fraction will generally contain a higher proportion of crushed cement and lower proportion of crushed aggregate than coarser fractions.

The fine fraction can be carbonated in any suitable manner, e.g., using systems and methods described in the previous sections.

Where the fine fraction is to be treated with CO2, in certain embodiments it can be supplied to a wash water treatment vessel for aqueous carbonation. Such systems are described in PCT Publication Nos. WO2018232507 and WO2021071980. The amount of fines as added to the wash water treatment vessel can be accompanied by a known amount of water (potable or clarified) in order to achieve or maintain a desired specific gravity in the wash water treatment vessel.

Additional processing can include further crushing or grinding the fines to a fine particle size, for example, comparable to the size and size distribution of cement, or of an SCM such as flyash (D×50 about 30 um), slag (D×50 about 10 um), or silica fume (D×50 about 0.2 um). A finer particle size can increase the reaction with CO2 and the carbonated recycled concrete fines can, in some cases, serve as a cement replacement. In certain embodiments, the median fraction size (D×50) is, e.g., 0.1-50 um, such as 0.2-30 um, for example, 0.2 um, in certain cases 10 μm, or even 30 μm. In certain embodiments D×50 is 30 μm or less. In certain embodiments D×50 is 10 um or less.

### Uptake of Carbon Dioxide

It will be appreciated that uptake of carbon dioxide by RCA can depend on a number of factors, including proportion of cement in the RCA, age of the RCA, type of cement in the RCA, and particle size of the RCA when exposed to carbon dioxide. Typically, concrete comprises about 10-20% cement, and the maximum carbon dioxide uptake can approach a theoretical maximum of 50% bwc; thus, an upper limit on carbon dioxide uptake is 10% by weight RCA (RCA concrete 20% cement, maximum uptake of 50% bwc achieved). In certain embodiments, carbonation of RCA results in a carbon dioxide uptake of at least 1-10% by weight RCA, such as at least 1-5% by weight RCA, in some cases at least 1-3% by weight RCA. In certain embodiments, carbonation of RCA results in a carbon dioxide up take of at least 1% by weight RCA. In certain em In certain embodiments, carbonation of RCA results in a carbon dioxide up take of at least 2% by weight RCA., carbonation of RCA results in a carbon dioxide up take of at least 3% by weight RCA.

### Evaluation of Carbonation

It is often desirable to determine the extent of carbonation of a concrete product, e.g., carbonated RCA as described herein, or concrete made with carbonated RCA. This can be useful or necessary for reporting and/or for carbon credit calculations. When extent of carbonation and quantity of carbonated material are known, the net converted CO2 can be calculated and, e.g., reported to a centralized ledger, e.g., for purposes of quantifying, verifying and/or commodifying CO2 reductions.

For RCA, extent of carbonation may be determined by one or more of estimation, based on carbon dioxide gas content and flow measurements during the carbonation process, and direct measurement. Techniques to measure the extent carbonation are well known in the art. Carbonation may be expressed as amount of carbon dioxide taken up per appropriate unit of mass, such as, in the case of carbonated RCA, weight of the aggregate, or, in the case of concrete produced using the carbonated RCA, per cubic meter, cubic yard, ton, or any other suitable unit of measure of concrete. In the latter case, other sources of carbon dioxide uptake, such as treatment of the wet concrete mix and/or carbonation of some or all of the mix water used in the concrete, such as carbonated wash water, may be added into the total amount of carbon dioxide sequestered in the concrete.

Thus, if it is desired to determine extent of carbonation, three exemplary protocols are:
1. Furnace testing. Extent of carbonation can be determined using a high temperature furnace to determine the amount of new CaCO₃ formed in the RCA during any carbonation treatment. The procedure has been correlated to traditional thermo gravimetric analysis (TGA) testing completed on cement paste samples (see Example 3). Samples of RCA are dried in a ventilated oven to remove any free moisture before heated to a high temperature. The dried samples are then heated in a furnace to various temperatures such as 300° C., 550° C., and 1000° C., or other suitable temperatures, and mass loss determined for each temperature interval. The mass loss at the temperature intervals correlates with dehydration and decarbonation of various chemical formations in the samples. The mass loss of the carbonated samples is compared and normalized to the mass loss of the same RCA before any treatment with CO2. This method correlates well with TGA analysis, which is commonly used for fine cementitious samples such as paste samples but is not usable for large samples such as RCA. The results also correlate with the mass increase of RCA samples, which is what is most commonly used in published research paper to quantify the uptake of CO2.
2. Mass of CO2 used. How efficiently each treatment uses the CO₂ can be determined using the test procedure described above and/or mass change of the RCA during treatment, or any other suitable technique. Once the efficiency of each treatment has been determined, the amount of CO₂ used during the treatment may be used to determine the amount sequestered in the RCA. The efficiency of each treatment may be affected by material properties such as aggregate moisture content, size, and age, as well as treatment parameters such as duration, CO₂ flow rate, and pressure. Other material properties and/or treatment parameters may also affect the treatment efficiency. The treatment efficiency must be determined by using either Method 1 described above or mass change of the sample, or other suitable technique. Once the efficiency is established for the equipment, the among of CO₂ used during treatment is multiplied with the treatment efficiency to show how much CO₂ was sequestered. This number can then be normalized to the weight of aggregate (g/kg agg) or cement (g/kg cem) as relevant and/or information are available.
3. Moisture content. When RCA is exposed to CO₂, the carbon dioxide reacts with the cement paste to produce calcium carbonate (CaCO₃). This reaction will also produce water, which will increase the moisture content of the aggregate and/or the ambient relative humidity within a treatment vessel. In treatment where the RCA is not immersed in water or solution, the carbonation reaction will increase the moisture content of the RCA. This increase in moisture content can be related to the amount of CO₂ sequestered. As shown below, it will depend on which formation in the cement paste is reacting with the CO₂ how many units of water are formed for a unit of CO₂ reacted. However, it can be estimated that for each unit of CO₂ sequestered approximately three units of water are formed. The moisture content of the RCA is determined before the treatment as well as after the treatment. The difference in moisture content is then converted to amount of CO₂ using the ratio of the molar masses of H₂O and CO₂.

### 2C—S—H Gel:

$$1.7 CaO \cdot Si O 2 \cdot 4 H 2 O + 0.3 Ca ( OH ) 2 + 2 CO2 \to 2 CaCO3 + SiO2 + 4.3 H2O Ratio of H2O / CO2 = 2.2$$

### 3C—S—H Gel

$$1.7 CaO \cdot SiO2 \cdot 4 H2O + 1.29 Ca ( OH ) 2 + 3 CO2 \to 3 CaCO3 + SiO2 + 5.31 H2O Ratio of H2O / CO2 = 1.8$$

### Tob C—S—H Gel

$$0.83 CaO \cdot SiO2 \cdot 1.3 H2O + 0.17 Ca ( OH ) 2 + CO2 \to CaCO3 + SiO2 + 1.4 H2O Ratio of H2O / CO2 = 1.4$$

### Jen C—S—H Gel

$$1.67 CaO \cdot SiO2 \cdot 2.1 H2O + \text{} 0.33 Ca ( OH ) 2 + \text{} 2 CO2 \to \text{} 2 CaCO3 + \text{} SiO2 + \text{} 2.44 H2O Ratio of H2O / CO2 = 1.2 \text{}$$

### Correlation of the Methods:

All three methods have been used to estimate the uptake of an RCA sample during a large-scale trial. The results are shown in the table below and show good correlation within. The efficiency of the trial treatment was determined to be 65%, i.e. 65% of the CO₂ used was sequestered in the RCA.

| | Method 1: | Method 2: | Method 3: |
|---|---|---|---|
| | Furnace | Mass of CO₂ | Change in |
| | testing | used | moisture |
| CO₂ uptake (%) | 0.77 | 0.79 | 0.87 |

### Uses of Carbonated RCA

The usual use of recycled concrete aggregates is in subsequent concrete production, and carbonated RCA may be used in these operations. In certain embodiments, carbonated RCA are used in the production of concrete, replacing ordinary aggregate in a certain proportion. Either coarse, fine, or both coarse and fine aggregates can be replaced. The proportion of aggregate that is carbonated RCA used in a given concrete batch can be any suitable proportion, such as 0.1-99.5, 0.1-90, 0.1-80, 0.1-70, 0.1-60, 0.1-55, 0.1-50, 0.1-45, 0.1-40, 0.1-35, 0.1-30, 0.1-25, 0.1-20, 0.1-15, 0.1-10, 0.1-5, 0.5-90, 0.5-80, 0.5-70, 0.5-60, 0.5-55, 0.5-50, 0.5-45, 0.5-40, 0.5-35, 0.5-30, 0.5-25, 0.5-20, 0.5-15, 0.5-10, 0.5-5, 2-90, 2-80, 2-70, 2-60, 2-55, 2-50, 2-45, 2-40, 2-35, 2-30, 2-25, 2-20, 2-15, 2-10, 2-5, 5-90, 5-80, 5-70, 5-60, 5-55, 5-50, 5-45, 5-40, 5-35, 5-30, 5-25, 5-20, 5-15, 5-10, 10-90, 10-80, 10-70, 10-60, 10-55, 10-50, 10-45, 10-40, 10-35, 10-30, 10-25, 10-20, 10-15, 20-90, 20-80, 20-70, 20-60, 20-55, 20-50, 20-45, 20-40, 20-35, 20-30, 20-25, 30-90, 30-80, 30-70, 30-60, 30-55, 30-50, 30-45, 30-40, 30-35, 40-90, 40-80, 40-70, 40-60, 40-55, 40-50, 40-45, 50-90, 50-80, 50-70, 50-60, or 50-55%, for example 0.5 to 95%, or 0.5-90%, or 20-100%, or 10-95% of the aggregate. In certain embodiments, 0.1-99.5, 0.1-90, 0.1-80, 0.1-70, 0.1-60, 0.1-55, 0.1-50, 0.1-45, 0.1-40, 0.1-35, 0.1-30, 0.1-25, 0.1-20, 0.1-15, 0.1-10, 0.1-5, 0.5-90, 0.5-80, 0.5-70, 0.5-60, 0.5-55, 0.5-50, 0.5-45, 0.5-40, 0.5-35, 0.5-30, 0.5-25, 0.5-20, 0.5-15, 0.5-10, 0.5-5, 2-90, 2-80, 2-70, 2-60, 2-55, 2-50, 2-45, 2-40, 2-35, 2-30, 2-25, 2-20, 2-15, 2-10, 2-5, 5-90, 5-80, 5-70, 5-60, 5-55, 5-50, 5-45, 5-40, 5-35, 5-30, 5-25, 5-20, 5-15, 5-10, 10-90, 10-80, 10-70, 10-60, 10-55, 10-50, 10-45, 10-40, 10-35, 10-30, 10-25, 10-20, 10-15, 20-90, 20-80, 20-70, 20-60, 20-55, 20-50, 20-45, 20-40, 20-35, 20-30, 20-25, 30-90, 30-80, 30-70, 30-60, 30-55, 30-50, 30-45, 30-40, 30-35, 40-90, 40-80, 40-70, 40-60, 40-55, 40-50, 40-45, 50-90, 50-80, 50-70, 50-60, or 50-55%, for example 0.5 to 95%, or 0.5-90%, or 20-100%, or 10-95% of the coarse aggregate used in a given batch of concrete is replaced with carbonated RCA. In certain embodiments, 0.1-99.5, 0.1-90, 0.1-80, 0.1-70, 0.1-60, 0.1-55, 0.1-50, 0.1-45, 0.1-40, 0.1-35, 0.1-30, 0.1-25, 0.1-20, 0.1-15, 0.1-10, 0.1-5, 0.5-90, 0.5-80, 0.5-70, 0.5-60, 0.5-55, 0.5-50, 0.5-45, 0.5-40, 0.5-35, 0.5-30, 0.5-25, 0.5-20, 0.5-15, 0.5-10, 0.5-5, 2-90, 2-80, 2-70, 2-60, 2-55, 2-50, 2-45, 2-40, 2-35, 2-30, 2-25, 2-20, 2-15, 2-10, 2-5, 5-90, 5-80, 5-70, 5-60, 5-55, 5-50, 5-45, 5-40, 5-35, 5-30, 5-25, 5-20, 5-15, 5-10, 10-90, 10-80, 10-70, 10-60, 10-55, 10-50, 10-45, 10-40, 10-35, 10-30, 10-25, 10-20, 10-15, 20-90, 20-80, 20-70, 20-60, 20-55, 20-50, 20-45, 20-40, 20-35, 20-30, 20-25, 30-90, 30-80, 30-70, 30-60, 30-55, 30-50, 30-45, 30-40, 30-35, 40-90, 40-80, 40-70, 40-60, 40-55, 40-50, 40-45, 50-90, 50-80, 50-70, 50-60, or 50-55%, for example 0.5 to 95%, or 0.5-90%, or 20-100%, or 10-95% of the fine aggregate used in a given batch of concrete is replaced with carbonated RCA. The carbonated RCA may be carbonated at the concrete production site, at a different site and transported to the concrete production site, or a combination thereof. In the former case, flue gas from a cement plant producing cement used in the concrete may be a source of some or all of the carbon dioxide used in carbonation. The carbonated RCA may be used in combination with other carbonation techniques. For example, in certain embodiments, concrete is produced using carbonated RCA and using one or both of carbonation of the wet concrete mix or carbonation of mix water, for example, using carbonated wash water, where the wash water is typically wash water produced in the course of concrete production, transportation, and use. Carbonation of wet concrete mixes is described in detail in U.S. Patent Publication No. 20160272542.

In certain embodiments, a concrete mix is produced using a combination of carbonated RCA and carbonation of the wet concrete mix (which carbonates cement in the mix). Proportions of carbonated RCA in the mix may be as given above. The wet mix may be exposed to carbon dioxide while mixing at any suitable concentration, such as not more than 3%, 2%, 1.5%, 1.2%, 1%, 0.8%, 0.7%, 0.6%, 0.5%, 0.4%, 0.3%, 0.2%, 0.1%, or 0.05% bwc (by weight cement) and/or at least 0.005, 0.01, 0.05, 0.1, 0.2, 0.3, 0.4, 0.5, 0.6, 0.7, 0.8, 0.9, 1.0, 1.1, 1.2, 1.3, 1.4, 1.5, 1.7, 2.0, 2.5% bwc, such as a dose of 0.01-3%, 0.01-2%, 0.01-1.5%, 0.01-1.2%, 0.01-1%, 0.01-0.8%, 0.01-0.6%, 0.01-0.5%, 0.01-0.4%, 0.01-0.3%, 0.01-0.2%, or 0.01-0.1% bwc, or a dose of 0.02-3%, 0.02-2%, 0.02-1.5%, 0.02-1.2%, 0.02-1%, 0.02-0.8%, 0.02-0.6%, 0.02-0.5%, 0.02-0.4%, 0.02-0.3%, 0.02-0.2%, or 0.02-0.1% bwc, or a dose of 0.04-3%, 0.04-2%, 0.04-1.5%, 0.04-1.2%, 0.04-1%, 0.04-0.8%, 0.04-0.6%, 0.04-0.5%, 0.04-0.4%, 0.04-0.3%, 0.04-0.2%, or 0.04-0.1% bwc, or a dose of 0.06-3%, 0.06-2%, 0.06-1.5%, 0.06-1.2%, 0.06-1%, 0.06-0.8%, 0.06-0.6%, 0.06-0.5%, 0.06-0.4%, 0.06-0.3%, 0.06-0.2%, or 0.06-0.1% bwc, or a dose of 0.1-3%, 0.1-2%, 0.1-1.5%, 0.1-1.2%, 0.1-1%, 0.1-0.8%, 0.1-0.6%, 0.1-0.5%, 0.1-0.4%, 0.1-0.3%, or 0.1-0.2% bwc. The carbon dioxide may be delivered to the wet concrete mix in any form, such as a mixture of solid and gaseous carbon dioxide, typically produced by letting liquid carbon dioxide be exposed to reduced pressure, such as atmospheric pressure. The final level of carbonation of the cement in the concrete mix depends on the efficiency of carbonation. Exemplary levels of carbonation of the cement in the concrete mix include 0.005-5%, 0.005-3%, 0.005-2%, 0.005-1%, 0.005-0.5%, 0.005-0.3%, 0.005-0.2%, 0.005-0.1%, 0.005-0.05%, 0.005-0.01%, 0.01-5%, 0.01-3%, 0.01-2%, 0.01-1%, 0.01-0.5%, 0.01-0.3%, 0.01-0.2%, 0.01-0.1%, 0.01-0.05%, 0.05-5%, 0.05-3%, 0.05-2%, 0.05-1%, 0.05-0.5%, 0.05-0.3%, 0.05-0.2%, 0.05-0.1%, 0.1-5%, 0.1-3%, 0.1-2%, 0.1-1%, 0.1-0.5%, 0.1-0.3%, 0.1-0.2%, for example, 0.05-5%, such as 0.05-1%, in some cases 0.05-0.5%.

In certain embodiments, a concrete mix is produced using a combination of carbonated RCA and carbonation of mix water used in the wet concrete mix. Proportions of carbonated RCA in the mix may be as given above. The mix water may be carbonated in any suitable manner. In certain embodiments, the mix water contains carbonated wash water, such as wash water produced in the concrete production site during production, transport, and use of the concrete made at the site. Carbonation of concrete wash water is described in detail in PCT Publication No. WO2018232507. Any suitable portion of the mix water may be carbonated water, such as carbonated wash water, e.g., 1-100, 1-80, 1-70, 1-60, 1-50, 1-40, 1-20, 1-10, 1-5, 5-100, 5-80, 5-70, 5-60, 5-50, 5-40, 5-20, 5-10, 5-5, 10-100, 10-80, 10-70, 10-60, 10-50, 10-40, 10-20, 30-100, 30-80, 30-70, 30-60, 30-50, 30-40, 50-100, 50-80, 50-70, 50-60%, such as 1-100%, for example 1-80%, in some cases 1-50%.

In certain embodiments, a concrete mix is produced using a combination of carbonated RCA, carbonation of the wet concrete mix, and carbonation of mix water used in the wet concrete mix. Proportions of each of the components in the wet mix, and dose of carbon dioxide used in treating the wet mix, can be any suitable proportion as described above. Compositions of the invention include compositions produced by any of these methods, including wet concrete mix comprising carbonated RCA, wet concrete mix comprising carbonated RCA and carbonated cement, wet concrete mix comprising carbonated RCA and carbonated mix water, such as mix water comprising carbonated wash water, and wet concrete mix comprising carbonated RCA, carbonated cement, and carbonated mix water, such as mix water comprising carbonated wash water.

In certain embodiments, carbonated RCA may be used as part of a road base. Tufa is a chemical sedimentary evaporate that can naturally occur in hot springs and alkaline lakes. It is porous rock of carbonate composition. The formation of tufa will depend on various environmental conditions such as temperature, relative humidity, precipitation, and rate of evaporation. There have been reports of tufa forming in highway structures where recycled concrete aggregate (RCA) was used for base structure. This formation can block drainage of the road, causing flooding and therefore lead to premature maintenance and increased cost.

Tufa formation from RCA is caused by dissolved ions in the water draining through the road base. RCA will increase the dissolved ions compared to natural rock due to the adhered mortar on the particles. If the RCA is carbonated before usage, some of the ions will then be bound into calcium carbonate phase and not available for leaching. This will reduce the concentration of leached ions and therefore significantly reduce or even eliminate the potential for tufa formation.

Thus, in certain embodiments carbonated RCA, such as carbonated RCA produced by one or more of the methods disclosed herein, is used as at least a portion of RCA used in a road base, such as at least 10, 20, 30, 40, 50, 60, 70, 80, or 90% of the RCA, or even 100% of the RCA used in a road base. In certain embodiments carbonated RCA, such as carbonated RCA produced by one or more of the methods disclosed herein, is used as at least 50% of RCA used in a road base. In certain embodiments carbonated RCA, such as carbonated RCA produced by one or more of the methods disclosed herein, is used as at least 80% of RCA used in a road base. In certain embodiments carbonated RCA, such as carbonated RCA produced by one or more of the methods disclosed herein, is used as 100% of RCA used in a road base.

The carbon dioxide used to produce carbonated RCA, carbonating the wet mix, and/or carbonating wash water, may be from any suitable source, e.g., sources as described herein. In certain embodiments, the source of some or all of the carbon dioxide used for one or more of RCA, wet mix carbonation, or wash water carbonation, is flue gas from a cement producing facility; such flue gas may be used as is, minimally treated, and/or treated to increase carbon dioxide content and/or change the state of carbon dioxide, e.g., liquify the carbon dioxide. In certain embodiments, the source of some or all of the carbon dioxide used for one or more of RCA, wet mix carbonation, or wash water carbonation, is flue gas from a cement producing facility that produces the cement used in the wet concrete mix. In certain embodiments the source of carbon dioxide is a process and/or facility in which carbon dioxide is produced as a byproduct of a desired product, generally at a purity that is, e.g., less than food-grade purity (e.g., less than 99.9% pure, in certain embodiments less than 99% pure). Such processes/facilities include ethanol production from crops such as corn; biogas production, e.g., anaerobic digestion of biological material such as landfill, crop residues, RNG, and the like.

Provided herein are systems for producing and/or utilizing carbonated RCA. In certain embodiments, provided herein is a system that includes a source of carbon dioxide operably connected to a facility that comprises recycled concrete aggregates and a system for delivering the carbon dioxide to the aggregates. The facility the comprises RCA may be a facility that produces and/or stores the RCA. The system is configured so that the carbon dioxide may be delivered at any appropriate stage of the production and/or storage of the RCA and in any appropriate manner, as described herein. The source of carbon dioxide may be any suitable source, as described herein; for example, the source may be a power plant or a cement plant, and the carbon dioxide may be, optionally, treated (e.g., concentrated and/or liquified) and transported to the RCA site. In this case the system includes a transportation system for transporting the carbon dioxide from its ultimate source to the site of RCA carbonation and, optionally, a treatment system to render the source material in suitable form. The system can be retrofintted using existing facilities, e.g., using existing aggregate storage facilities as treatment sites. The system may be a modular system, e.g., a system suitable for transport to an existing concrete recycling site. In certain cases, the system is built as a stand-alone system. Appropriate sensors and control mechanisms can be included, such as carbon dioxide sensors, flow rate sensors, temperature sensors, moisture sensors, pressure sensors, etc., operably connected to a controller, as described more fully elsewhere herein. In certain embodiments, more than one system is operably connected to a central controller in a network; alternatively or additionally, a plurality of recycled aggregate producers can be connected to a central carbonation facility with a controller for the central facility, as described further herein. Networking can also include networking of concrete production facilities, as described in U.S. Patent Publication No. 20160272542. The system may further include a concrete producing facility that uses carbonated RCA produced in the RCA carbonation system in concrete produced at the concrete producing facility. A transportation system for transporting the carbonated RCA to the concrete producing facility may be included. In certain embodiments, the concrete producing facility is configured to deliver carbon dioxide to wet concrete mix produced at the facility; in certain embodiments, the system includes a system to delivery carbon dioxide in a desired form and dose to the wet concrete mix, such as a system to convert liquid carbon dioxide to solid and gaseous carbon dioxide which is delivered to the mixing wet concrete mix. The source of the carbon dioxide delivered to the mixing concrete may be the same as or different from the source for carbonating RCA. In certain embodiments, the concrete producing facility is configured to deliver mix water to a concrete mix where the mix water includes carbonated water, such as carbonated wash water, e.g., wash water produced at the facility and/or during transportation and use of the concrete produced at the facility; in certain embodiments, the system includes a system to carbonate wash water produced by the facility and/or in transport and use of concrete produced at the facility. The source of carbon dioxide to carbonate water, e.g., wash water, may be the same as or different from the source of carbon dioxide to carbonate RCA. In certain embodiments, the same source of carbon dioxide is used for carbonation of RCA and carbonating mixing wet concrete and/or carbonating water such as wash water; in certain embodiments, the source of carbon dioxide includes a cement plant, such as a cement plant that produces cement used in the concrete mix produced at the concrete producing facility. In certain embodiments, the system includes a carbonation determination system, to determine the level of carbonation of one or more of the components of the concrete mix (RCA, cement, and/or mix water) and/or the final mix, and/or hardened concrete from the mix. The carbonation determination system may use estimates (based on, e.g., carbon dioxide delivery, treatment time, and the like), direct measurement by methods known in the art, or a combination thereof. If the system is part of a network, the carbonation determination system may be in communication with other such systems from other concrete producing sites.

### EMBODIMENTS

In embodiment 1 provided is a method for carbonating recycled concrete aggregate (RCA) comprising exposing the RCA to carbonated water. In embodiment 2 provided is the method of embodiment 1 further comprising treating the RCA to produce particles of RCA. In embodiment 3 provided is the method of embodiment 2 further comprising separating the particles of RCA into one or more desired size or sizes or range or ranges of sizes. In embodiment 4 provided is the method of embodiment 3 further comprising determining the degree to which the particles of RCA can be carbonated. In embodiment 5 provided is the method of any one of the preceding embodiments wherein the RCA is contained in a watertight or substantially watertight vessel. In embodiment 6 provided is he method of embodiment 5 wherein the vessel is open to the atmosphere. In embodiment 7 provided is the method of embodiment 5 wherein the RCA is completely immersed in carbonated water. In embodiment 8 provided is the method of embodiment 1 wherein the RCA is unconfined. In embodiment 9 provided is the method of any one of embodiments 5 to 8 further comprising causing carbonated water to move through the RCA. In embodiment 10 provided is the method of embodiment 9 wherein the RCA is unconfined and causing the carbonated water to move through the RCA comprises contacting the unconfined RCA with the carbonated water in such a way that the carbonated water percolates down through the unconfined RCA in a uniform or substantially uniform manner, emerging at the bottom of the unconfined RCA. In embodiment 11 provided is the method of embodiment 9 wherein the RCA is confined and causing the carbonated water to move through the RCA comprises introducing carbonated water at or near the surface of the water in which the RCA is immersed in a uniform or substantially uniform manner and causing the water to flow through the immersed RCA to an exit site that is at or near the bottom of the immersed RCA. In embodiment 12 provided is the method of embodiment 9 further comprising separating or substantially separating water that has moved through the RCA from the RCA to create a pool of separated water. In embodiment 13 provided is the method of embodiment 12 further comprising contacting water from the pool of separated water with carbon dioxide. In embodiment 14 provided is the method of embodiment 13 further comprising transporting water as it is being exposed to carbon dioxide back to the RCA. In embodiment 15 provided is the method of embodiment 14 wherein the transporting occurs in one or more conduits, wherein the water flows in the conduit or conduits from the pool to one or more sprayers or other mechanism to distribute the re-carbonated water back to the RCA. In embodiment 16 provided is the method of embodiment 14 further comprising determining one or more characteristics of (a) a difference between a first and a second pH of water, wherein the first pH is of the water before re-carbonation, e.g., pH in the pool, and the second pH is of the water after re-carbonation of the water, e.g., just before it is distributed back to the RCA; (b) water temperature at one or more points; (c) non-H+ ion activity of water at one or more points; (d) time of treatment. In embodiment 17 provided is the method of embodiment 16 further comprising determining, based at least in part on the one or more characteristics, whether or not to modulate flow of water and/or carbon dioxide. In embodiment 18 provided is the method of embodiment 17 wherein determining comprises determining to stop flow of both water and carbon dioxide, and communicating to one or more actuators, such as valves, to stop the flow. In embodiment 19 provided is a system for carbonating recycled concrete aggregates comprising (i) a pile of unconfined RCA, wherein the RCA is present as particles in a desired size or range of sizes and comprises a top, a bottom, and an outer surface; (ii) a source or sources of water; (iii) one or more conduits operably connected to the source or sources of water and to one or more water distribution systems, wherein the one or more conduits further comprise a system for contacting the water with carbon dioxide as it moves through the conduit; (iv) a source of motive power, e.g., a pump, to move the water through the conduit from the source to the one or more water distribution systems, and out of the one or more water distribution systems onto at least part of the outer surface of the pile, so that the carbonated water percolates through the pile, emerging at the bottom of the pile. In embodiment 20 provided is the system of embodiment 19 wherein the one or more water distribution systems comprise one or more sprayers. In embodiment 21 provided is the system of embodiment 19 or embodiment 20 wherein the one or more water distribution systems, e.g., sprayers are situated so that water that emerges from the one or more water distribution systems, e.g, sprayers and contacts the outer surface percolates through the pile of RCA in a uniform or substantially uniform manner. In embodiment 22 provided is the system of any one of embodiments 19 to 21 comprising a plurality of water distribution systems, e.g, sprayers, e.g., 2, 3, 4, 5, 6, 7, 8, 9, 10 or more than 10. In embodiment 23 provided is the system of any one of embodiments 19 to 21 further comprising (v) a vessel to collect the water that emerges from the bottom of the pile to create a source of water. In embodiment 24 provided is the system of any one of embodiments 19 to 23 wherein the one or more conduits each has a length, and wherein the system to contact the water with carbon dioxide in a conduit comprises less than 80, 70, 60, 50, 40, 30, 20, or 10% of the length of that conduit and is situated at or near the connection of the conduit to the source of water. In embodiment 25 provided is the system of any one of embodiments 19 to 24 wherein the system for contacting the water with carbon dioxide comprises a connecting conduit for transporting carbon dioxide from a source of carbon dioxide to the one or more conduits and connected to the one or more conduits in such a manner as to provide contact between the carbon dioxide and the water. In embodiment 26 provided is the system of embodiment 25 wherein the carbon dioxide flows from the connecting conduit to a conduit disposed within the one or more conduits and configured to allow the carbon dioxide to contact the water. In embodiment 27 provided is the system of any one of embodiments 19 to 26 further comprising a first pH sensor to determine a first pH of water at the source, i.e., after it has percolated through the RCA but before it is re-carbonated, and a second sensor to determine a second pH of water after it is re-carbonated. In embodiment 28 provided is the system of any one of embodiments 19 to 27 further comprising a controller for controlling the system. In embodiment 29 provided is the system of embodiment 28 wherein the controller is configured to adjust flow of carbon dioxide to the system to contact the water with carbon dioxide and/or flow of water through the conduit, based at least in part on one or more of (a) the difference between the first pH and the second pH; (b) the time that flow has occurred; (c) the volume of water flowed onto the pile; (d) a first and second temperature (e) a first and second non-H+ ion content. In embodiment 30 provided is the system of embodiment 29 wherein the controller adjust flow based, at least in part, on the difference between the first and second pHs. In embodiment 31 provided is the system of any one of embodiments 19 to 30 comprising a plurality of unconfined piles, each of which comprises (ii) a source or sources of water (iii) one or more conduits operably connected to the source or sources of water and to one or more water distribution systems, wherein the one or more conduits further comprise a system for contacting the water with carbon dioxide as it moves through the conduit; (iv) a source of motive power, e.g., a pump, to move the water through the conduit from the source to the one or more water distribution systems, and out of the one or more water distribution systems onto at least part of the outer surface of the pile, so that the carbonated water percolates through the pile, emerging at the bottom of the pile. In embodiment 32 provided is the system of embodiment 31 wherein the plurality of piles comprises at least 2, 3, 4, 5, 6, 7, 8, 9, 10 piles. In embodiment 33 provided is the system of embodiment 31 or embodiment 32 further comprising a system to transport water that emerges from the bottoms of at least a portion of the plurality of piles to a common vessel. In embodiment 34 provided is a system for carbonating recycled concrete aggregates comprising (i) a vessel to contain RCA and carbonated water in which the RCA is immersed, wherein (a) the RCA is present as particles in a desired size or range of sizes; (b) the water has a top surface (c) the containment vessel is watertight or substantially watertight. (ii) a water collection pool separated from the RCA by a permeable layer and, optionally, an impermeable layer; (iii) one or more conduits operably connected to the water collection pool and to one or more water distribution systems, e.g., sprayers, situated to distribute water from the one or more water distribution systems, e.g. sprayers, to or near the top surface of the water; (iv) a source of motive power, e.g., a pump, to move the water through the conduit from the source to the one or more sprayers, and out of the one or more sprayers. In embodiment 35 provided is the system of embodiment 34 comprising both a permeable layer and an impermeable layer. In embodiment 36 provided is the system of embodiment 35 wherein the permeable layer is situated below the impermeable layer. In embodiment 37 provided is the system of embodiment 36 wherein the permeable layer is configured and situated so that only water from the bottom 5, 10, 15, 20, 25, 30, 40, 50, 60%, e.g, bottom 15%, of the RCA can move through it to the water collection pool. In embodiment 38 provided is the system of any of embodiments 34-37 further comprising a system for contacting the water with carbon dioxide as it moves through the conduit or conduits. In embodiment 39 provided is the system of embodiment 38 wherein the conduit or conduits each has a length, and wherein the system to contact the water with carbon dioxide comprises less than 80, 70, 60, 50, 40, 30, 20, or 10% of the length of a particular conduit and is situated at or near the connection of the conduit to the source of water. In embodiment 40 provided is the system of embodiment 38 or embodiment 39 wherein the system for contacting the water with carbon dioxide comprises a connecting conduit for transporting carbon dioxide from a source of carbon dioxide to the one or more conduits and connected to the one or more conduits in such a manner as to provide contact between the carbon dioxide and the water. In embodiment 41 provided is the system of embodiment 40 wherein the carbon dioxide flows from the connecting conduit to a conduit disposed within the one or more conduits and configured to allow the carbon dioxide to contact the water. In embodiment 42 provided is the system of any one of embodiments 34 to 41 further comprising a vessel to which water from the collection area is transported, and to which is connected the conduit In embodiment 43 provided is a method comprising (i) placing unused wet concrete in a vessel; (ii) contacting the unused wet concrete with carbon dioxide while the unused wet concrete is mixing to carbonate the used wet concrete, producing carbonated unused wet concrete; and (iii) removing the carbonated unused wet concrete from the vessel. In embodiment 44 provided is the method of embodiment 43 further comprising (iv) placing the carbonated unused wet concrete on a surface at a first site in a layer of desired thickness; (v) allowing the carbonated unused concrete to set and harden; and (vi) treating the hardened concrete to divide it into smaller portions. In embodiment 45 provided is the method of embodiment 44 further comprising (vii) transporting the smaller portions to a second site In embodiment 46 provided is the method of embodiment 45 further comprising (viii) allowing the smaller portions to continue to harden until a desired hardness is reached and/or a desired period of time has elapsed to produce hardened portions; and (ix) treating the hardened portions to create smaller particles, e.g., for use as aggregates. In embodiment 47 provided is the method of embodiment 46 further comprising (x) separating the smaller particles into a desired size or range of sizes to produce sized hardened carbonated unused concrete. In embodiment 48 provided is the method of embodiment 47 further comprising using the sized hardened carbonated unused concrete as aggregate in a subsequent batch of concrete, and/or as road way filler. In embodiment 49 provided is a system for carbonating unused wet concrete comprising (i) a vessel to hold and mix the unused wet concrete; (ii) an apparatus to introduce a source of carbon dioxide to the unused wet concrete, thereby producing carbonated unused wet concrete. In embodiment 50 provided is the system of embodiment 49 wherein the source of carbon dioxide comprises solid and gaseous carbon dioxide that is contacted with the mixing unused wet concrete. In embodiment 51 provided is the system of embodiment 49 or embodiment 50 further comprising (iii) a system to remove carbonated unused wet concrete from the vessel. In embodiment 52 provided is the system of embodiment 51 further comprising (iv) a system for spreading the carbonated unused wet concrete on a surface to a desired thickness at a first site. In embodiment 53 provided is the system of embodiment 52 further comprising (v) a system for reducing the carbonated unused wet concrete into smaller portions after the carbonated unused wet concrete has set and hardened. In embodiment 54 provided is the system of embodiment 53 further comprising (vi) a system for moving the smaller portions produced in (v) to a second site, where they can continue to harden. In embodiment 55 provided is the system of embodiment 54 further comprising (vii) a system to reduce sizes of the smaller portions to produce particles of the hardened carbonated concrete and to separate the particles into particles of a desired size or range of sizes.

### EXAMPLES

### Example 1

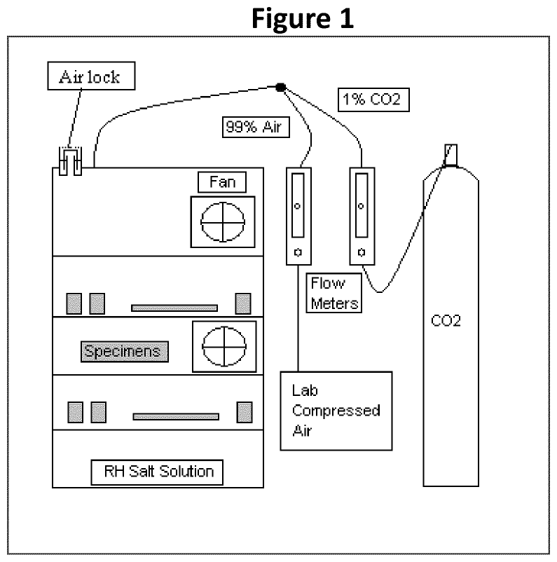

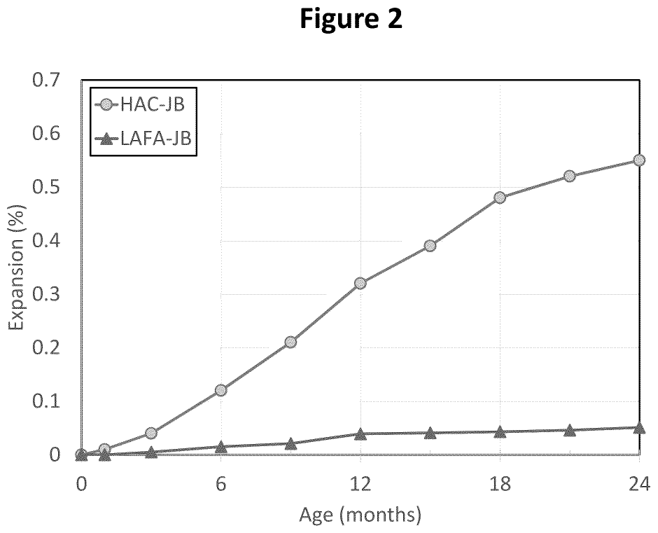

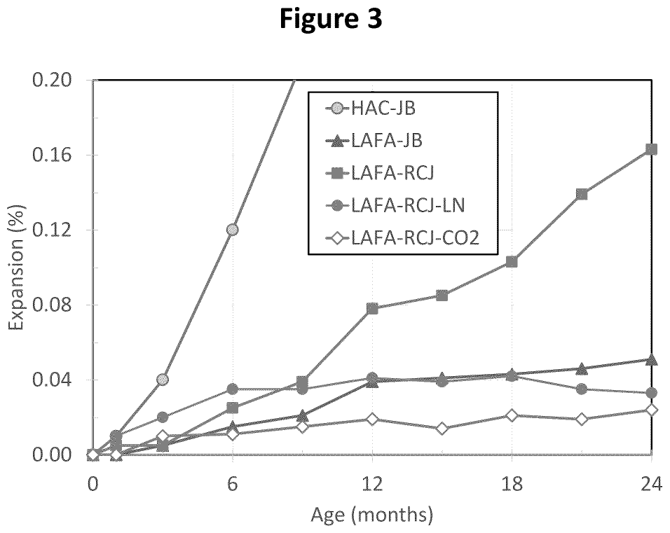

A study was conducted using recycled concrete aggregate (RCA) produced from crushing mortar containing a highly-reactive (Jobe) sand and a high-alkali cement. Mortar was produced using highly reactive Jobe aggregate and high-alkali cement (1.12% Na₂Oe). Mortar prisms were produced then seal-cured in plastic bags for 3 months. The mortar was crushed to produce coarse aggregate in the size range from 5 to 20 mm. The coarse aggregate was then subjected to three different treatments: 1) No treatment; 2) stored in 30% LiNO₃ for 28 days; 3) stored at 55-65% RH in a CO2-enriched atmosphere (1% CO2) for 91 days. See FIG. 1 for the apparatus used for the carbonation treatment. Concrete samples were then produced with the carbonated RCA (RCA-CO2) and non-carbonated RCA (RCA-ASR). The binder used in the concrete was a blend of 80% low-alkali cement plus 20% fly ash. This blended cement has been shown to be effective in preventing ASR expansion when used with the Jobe aggregate. Concrete prisms containing RCA-ASR expanded significantly (0.162% in 2 years) when stored over water in sealed containers at 38° C. whereas concrete produced with RCA-CO2 did not (<0.040% at 2 years). See FIGS. 2 and 3. Without being bound by theory, it is thought that, in the case of the uncarbonated RCA, there is a sufficient concentration of alkali hydroxides within the mortar portion of the RCA to fuel ASR with the reactive silica in the sand particles. However, in the carbonated RCA the concentration of alkali hydroxides is significantly reduced by the carbonation process and this prevents ASR expansion despite the abundance of reactive silica present in the RCA.

Materials A high-alkali (HA) and low-alkali (LA) Portland cement, and a single source of low-calcium fly ash (FA) were used in the study; the chemical composition of the cementing materials is given in Table 1. A single source of highly-reactive sand (JB) was used in the study. Concrete mixtures incorporated either a non-reactive siliceous gravel (NC) or a non-reactive natural river sand (NF). A solution of 30% lithium nitrate (LN) was used.

TABLE 1

| | SiO₂ | Al2O₃ | Fe2O₃ | CaO | MgO | Na₂O | K₂O | SO₃ | Na₂Oe |
|---|---|---|---|---|---|---|---|---|---|
| HAPC | 19.6 | 5.33 | 2.12 | 61.8 | 2.36 | 0.30 | 1.24 | 4.17 | 1.12 |
| LAPC | 21.6 | 4.81 | 2.10 | 62.1 | 2.43 | 0.22 | 0.36 | 3.41 | 0.46 |
| FA | 48.5 | 19.0 | 13.6 | 5.24 | 2.26 | 2.25 | 1.87 | 2.45 | 3.75 |

Production and Treatment of Recycled Concrete Aggregate (RAC) Prisms (75×75×300 mm) were cast using a mortar produced with high-alkali Portland cement (HA) and Jobe sand (JB) using sand:cement:water=3:1:0.5. The prisms were sealed in plastic bags and stored at 23° C. for 3 months. The mortar prisms were then fractured into chunks using a hammer and the chunks passed through a jaw crusher to reduce the particle size to pass a 20-mm sieve. The sub-20 mm material was screened on a 5-mm sieve to remove the fine fraction. The 20-5 mm material was used for all testing and was identified as RJC. The 20-5 mm material was air-dried in the laboratory prior to one of the following treatments: RJC: untreated recycled Jobe-concrete aggregate; RJC-LN: RJC immersed in 30%-LiNO₃ solution for 28 days; RJC-CO2: RJC aggregate stored at 55 to 65% RH in a CO₂-enriched atmosphere (1% CO₂) for 91 days. A schematic of the carbonation chamber is shown in FIG. 1.

2.3 Testing of RCA for Alkali-Silica Reaction (ASR) The Jobe sand (JB), the untreated RCA (RJC) and the treated RAC (RJC-LN and RJC-CO2) were tested using the concrete prism test (ASTM C1293). Briefly, this test involves producing concrete prisms (75×75 mm×250-mm gauge length) that are fitted with stainless-steel inserts at the ends to allow length-change measurements to be made. The prisms are stored over water in sealed containers stored at 38° C. and are periodically removed to determine changes in length and mass. The concrete mix design incorporates 420 kg/m³ of cementing material and w/cm in the range of 0.42 to 0.45. The cementing material was comprised of either 100% high-alkali cement, designated HA, or a combination of 80% low-alkali cement plus 20% fly ash, designated LAFA. Note that none of the concrete mixtures used in this study were boosted with NaOH during mixing. Table 2 presents the concrete mixtures that were tested in this study.

TABLE 2
Composition of Concrete Prism Tests

| | Cementing | Reactive | Non-Reactive |
|---|---|---|---|
| Mix ID | Material | Aggregate | Aggregate |
| HA-JB | HA Cement | JB Sand | Non-Reactive |
| LAFA-JB | LA Cement + Fly | | Coarse |
| | Ash | | |
| HA-RJC | HA Cement | RJC untreated | Non-Reactive |
| LAFA-RJC | LA Cement + Fly | | Fine |
| | Ash | | |
| HA-RJC- | HA Cement | RJC Carbonated | |
| CO2 | | | |
| LAFA- | LA Cement + Fly | | |
| RJC-CO2 | Ash | | |
| LAFA- | LA Cement + Fly | RJC Lithium- | |
| RJC-LN | Ash | Treated | |

Results Concrete with Jobe Sand. FIG. 2 shows the expansion of the concrete prisms containing alkali-silica reactive Jobe sand and non-reactive coarse aggregate. As expected the concrete containing high-alkali (HA) cement expanded very rapidly showing deleterious levels of expansion (>0.04%) and cracking after just 3 months; the total expansion at 2 years was 0.550%. The concrete produced with Jobe sand in combination with low-alkali (LA) cement and fly ash (FA) did not exhibit deleterious expansion (>0.04%) throughout the two-year period (0.039% at 2 years).

Concrete with Untreated Recycled Concrete Aggregate (RJC) FIG. 3 shows the expansion of concrete prisms produced with the untreated RJC material as the coarse aggregate and a non-reactive fine aggregate. Concrete containing the RJC and HA cement expanded rapidly but compared with the mix with HA cement and Jobe sand, the rate of expansion was slower and the ultimate expansion was less. The concrete with the RJC material and the low-alkali cement/fly ash combination (LAFA) also expanded but to a lesser degree than with the HA cement.

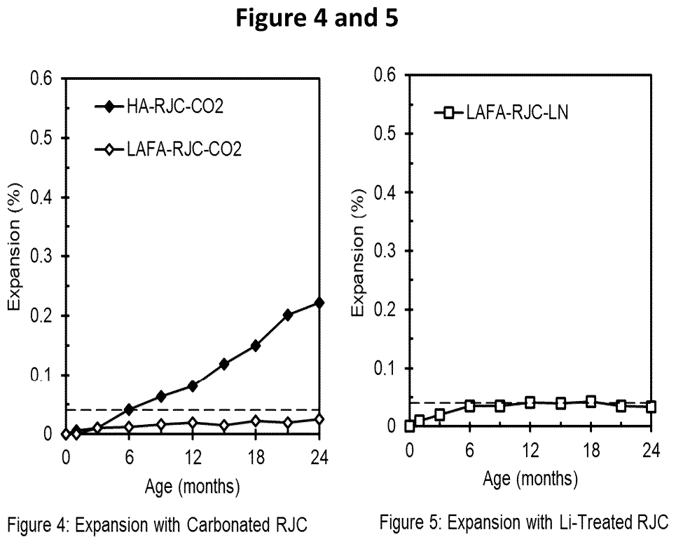

Concrete with Carbonated Recycled Concrete Aggregate (RJC-CO2) FIG. 4 shows the results for concrete produced with the carbonated RJC material (RJC-CO2) as the coarse aggregate and a non-reactive fine aggregate. Concrete with HA cement did show some expansion which was significantly lower than the other concretes with HA cement. The concrete produced with the LAFA combination did not exhibit deleterious expansion throughout the 2-year period; the expansion at 2 years was just 0.024% and there was no evidence of surface cracking at that time.

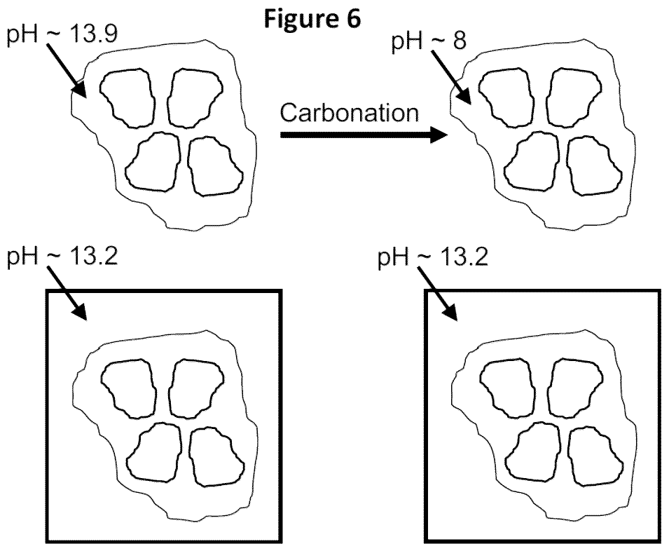

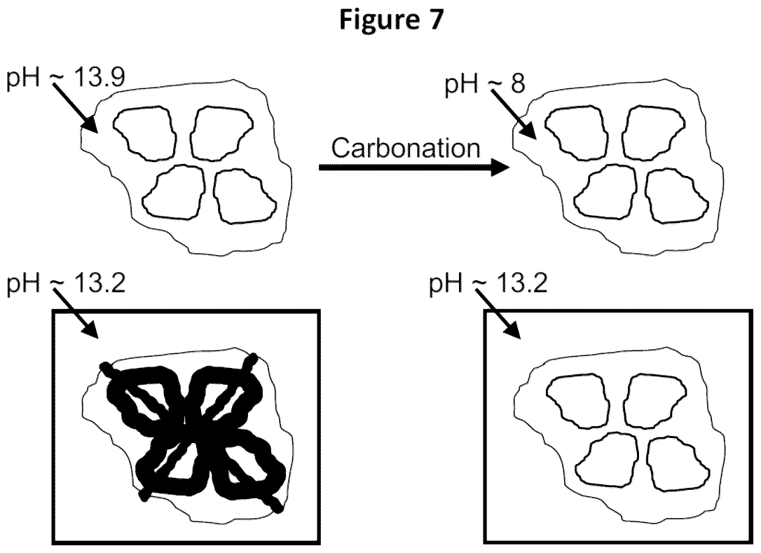

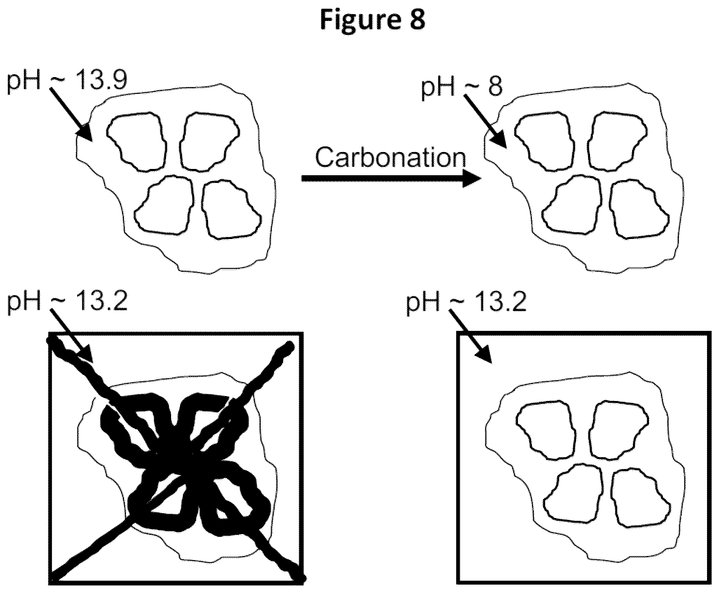

Concrete with Lithium-Treated Recycled Concrete Aggregate (RJC-LN) FIG. 5 shows expansion data for the lithium-treated RJC aggregate (RJC-LN) and the 80/20 combination of LA cement/fly ash (LAFA). The concrete showed a small amount of deleterious expansion, 0.042%, at 18 months and this was accompanied by very faint surface cracks measuring approximately 0.1 mm in width. The expansion did not increase beyond this amount with further exposure; indeed, the 2-year expansion was slightly lower at 0.033%. Unfortunately, there are no results for the combination of HA cement and RJC-LN

DISCUSSION The data show that the use of recycled concrete aggregate produced from ASR-affected concrete can lead to expansion and cracking of new concrete unless the aggregate is treated. Previous workers have shown that such expansion can be prevented by using suitable amounts of pozzolans, but that the amounts required are more than that needed for virgin reactive aggregate. In the case studied here, expansion was observed even when the binder was comprised of a low-alkali cement (0.46% Na₂Oe) in combination with 20% of a low-calcium fly ash. This same cementitious material combination (LAFA) did not lead to expansion and cracking of the concrete with the virgin Jobe aggregate.

In the case of the expansion and cracking observed with concrete comprising the untreated RJC aggregate and the LAFA cementing system, it is proposed that the source of alkalis required to promote ASR in the new concrete is within the RJC aggregate itself. FIG. 6 shows a schematic of the RJC (upper left) and the fresh concrete produced with the RJC (upper right). The RJC was produced with HA cement and Jobe sand, and was just 3 months old when the fresh concrete was mixed. At this age there is still considerable potential for further reaction within the RJC particles as both alkali hydroxides and reactive silica are still present. The potential for further ASR within the particles is demonstrated by the amount to expansion observed beyond 3 months in the concrete containing HA cement and virgin Jobe sand (HA-JB in FIG. 2).

Carbonating the RJC prior to use in fresh concrete will reduce the pH from somewhere in excess of 13.1 to approximately 8 and there will be insufficient alkali hydroxides within the particles to sustain ASR. Consequently, producing fresh concrete with the carbonated RJC-CO2 aggregate and a “low-alkali binder system” such as LAFA results in no expansion because there is an insufficient supply of alkali hydroxides in the system to fuel ASR despite the abundance of reactive silica (e.g. unreacted Jobe) that remains. If, however, this same aggregate (RJC-CO2) is combined with a “high-alkali binder system” such as HA cement, expansion can result as the alkali hydroxides that are present in the fresh paste can diffuse into the carbonated recycled aggregate particles and react with any remaining unreacted silica (Jobe) in these same particles.

An alternative approach to “neutralizing”, by carbonation, the alkali hydroxides that remain in the original cement paste phase of the RAC particles is to “balance” the concentration of Na⁺ and K⁺ ions with a sufficient concentration of Li⁺ ions. It is well-established that the expansion of concrete containing certain alkali-silica reactive aggregates can be prevented by adding a sufficient quantity of lithium. Generally, the amount of lithium required increases as the availability of sodium and potassium increase and it has been shown that establishing a lithium-to-sodium-plus-potassium-molar ratio of [Li]/[Na+K]≥0.74 is usually sufficient. The lithium-treatment of the RJC was borderline effective when the RJC-LN material was combined with the “low-alkali binder system” (LAFA). It is suspected that this treatment would be less effective if RJC-LN was combined with a “high-alkali binder system” as the value of [Li]/[Na+K] will likely be diminished. It should be noted that lithium-based admixtures are not effective in preventing ASR expansion with all types of alkali-silica reactive aggregate.

Conclusions Recycled concrete aggregate (RCA) was produced by crushing and grading (20-5 mm) three-month-old mortars containing high-alkali cement and highly-reactive sand (Jobe). This RCA was used either without treatment (RJC) or following carbonation (RJC-CO2) or lithium-soaking (RJC-LN) to produce fresh concrete using either a high-alkali (HA) cement or a combination of low-alkali cement plus fly ash (LAFA). From the results of concrete-prism expansions tests, the following conclusions can be drawn: ASR expansion can occur when the untreated RJC is used with a “low-alkali binder system” (LAFA); ASR expansion can be prevented by carbonating the RJC (RJC-CO2) and combining it with a “low-alkali binder system” (LAFA); ASR expansion can occur with the carbonated aggregate (RJC-CO2) is combined with a “high-alkali binder system” (HA); Limited ASR expansion (0.042%) accompanied by very fine microcracks (˜0.1 mm) was observed when the RJC was treated with lithium (RJC-LN) and combined with LAFA.

### Example 2

In this Example, quantifying the potential carbon dioxide uptake of RCA is described.

The amount of CO₂ an RCA is capable of sequestering will depend on various factors, such as particle size, age, previous carbonation, and the parent concrete mix design. Many researchers have looked at how these parameters affect the sequestering potential and younger, finer particles usually have higher potential for CO₂ uptake. Most research projects have focused on using concrete made in the laboratory where the mix design, curing, and age are known. However, if carbonation treatments of RCA for used in the field become practical it will be useful to evaluate RCA sources that may have combination of various parent concrete as well as of multiple age and previous carbonation. It is therefore useful to quantify how much CO₂ an RCA source can sequester and if treatments would be practical.

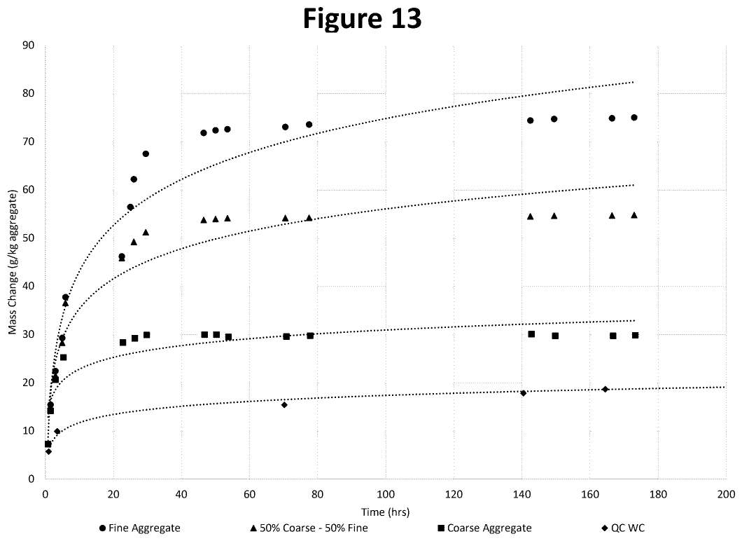

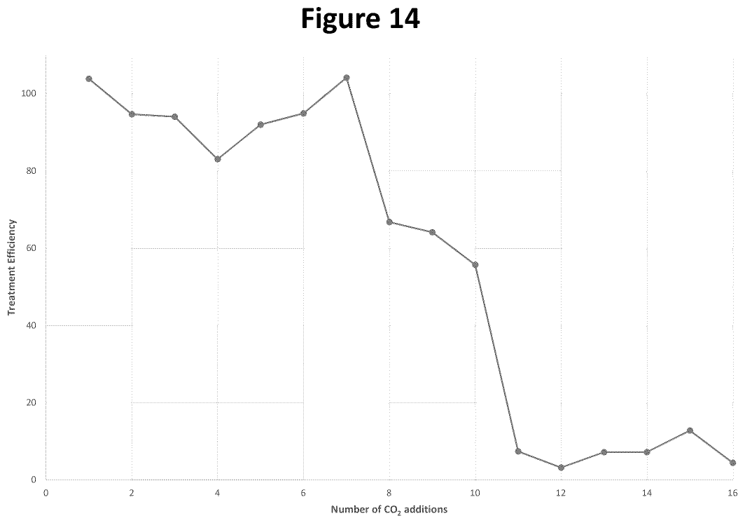

A protocol and test procedure have been developed to measure the potential of any RCA to sequester CO₂. Samples of RCA, with the same grading curve as proposed for treatment, were placed in sealed pressure vessels. The samples were fine aggregate; 50% coarse aggregate and 50% fine aggregate; coarse aggregate; and an older recycled concrete aggregate graded as a roadbase material (so including a combination of coarse and fine aggregate (QC WC in FIG. 13). The latter is more representative of returned concrete at a RCA plant than the coarse and fine aggregates, ass those were treated at a young age (around 7 days or so). Each vessel was equipped with a pressure gauge to monitor any changes in pressure and its weight has been recorded. Prior to testing, the RCA cannot be oven dried nor can it be soaking wet. Moisture content can be anywhere from 1% to saturated. The maximum moisture content will depend on the aggregate, as the water absorption will be different. Preferably, the aggregate should not be fully saturated, such as having a moisture content of 30-70% of maximum water absorption.

At the same time as the samples were placed in the vessels, another sample was used to determine the moisture content of the aggregate at the start of the test. Initial mass of the test sample in the vessel was determined. A known quantity of solid CO₂ was added to the vessel and the vessel was sealed. The mass of the sealed vessel was determined. As the CO₂ sublimated the pressure within the vessel built up. The amount of CO₂ added was small enough so that the pressure within the bottle did not exceed the capability of the vessel. The ideal gas law can be used to determine what amount is suitable. The amount of CO₂ added was determined and once the vessel is sealed the pressure is monitored.

In the first three days of testing, CO₂ was added to the vessel a plurality of times each day, e.g., at least two, preferably at least three times throughout a workday. If the pressure within the vessel dropped to 0, more CO₂ was added even though that resulted in more than two or three additions of CO₂ in the vessel within a day. The weight of the vessel was monitored while sealed to detect any leakage from the system. The weight of the vessel can also be monitored any time it is opened to add more CO₂ to monitor the mass change of the aggregate. After about 60 to 72 hours most aggregates have reached the maximum uptake. FIG. 13 shows mass change vs time for the four different RCA types. As expected, the fine aggregate took up more carbon dioxide than the coarse aggregate with 50-50 being intermediate between the two and QCWC the lowest; however, all four RCAs demonstrated the same time course of saturation. This was recognized by limited mass gain between CO₂ additions and how the efficiency of each CO₂ addition drops below 10%, as seen in the FIG. 14. When this limit was reached the RCA was considered to have absorbed or sequestered as much CO₂ as it will do. Any remaining potential sequestration would be extremely slow and the amount can be considered negligible.

Once the final masses of the samples were determined the RCA was extracted from the vessel and the final moisture content determined. The CO₂ uptake of the samples can then confirmed using, e.g., the furnace testing procedure described elsewhere herein. As the maximum uptake of CO₂ will depend on the aggregate gradation, it is expected that coarsely graded aggregates could potentially absorb more CO₂ if they would be crushed further, even after going through this procedure. Therefore it is important that the aggregate's CO₂ uptake potential is evaluated using material with same gradation as will be used for treatment. This protocol can evaluate and comparing the potential uptake of any RCA source, regardless of age, previous carbonation, mix design, contamination etc.

Efficiency of the CO2 additions for each interval: (DM/MCO2)*100%
Where:
DM=mass change after CO2 addition
M_{CO2}=mass of CO2 added
Potential CO2 uptake of RCA is calculated using the following equation:

$$Max CO 2 = {DM}_{TOT} / {M}_{AGG}$$

Where:
Max CO2=the maximum potential CO2 uptake of RCA tested
DM_{TOT}=Cumulative mass change of the aggregate for all intervals
M_{AGG}=Initial mass of the aggregate tested

### Example 3

In this example, three different methods of quantifying carbon dioxide sequestration into RCA are described

### 1. Furnace Testing

The mass of CO2 sequestered in a sample was measured by comparing the mass loss of a treated RCA sample to non-treated sample when the samples were heated from 550° C. to 1000° C. Extent of carbonation was determined using a high temperature furnace to determine the amount of new CaCO₃ formed in the RCA during any carbonation treatment. The procedure was correlated to traditional thermo gravimetric analysis (TGA) testing completed on cement paste samples. Samples of RCA were dried in a ventilated oven to remove any free moisture before being heated to a high temperature. The dried samples were then heated in a furnace to various temperatures such as 300° C., 550° C., and 1000° C. and mass loss determined for each temperature interval. The mass loss at the temperature intervals correlates with dehydration and decarbonation of various chemical formations in the samples. The mass loss of the carbonated samples was compared and normalized to the mass loss of the same RCA before any treatment with CO₂. This method correlated well with TGA analysis, which is commonly used for fine cementitious samples such as paste samples but is not usable for large samples such as RCA. See FIG. 14. The following equations apply

$${M}_{CaCO 3} = {DM}_{1000} - {DM}_{550}$$

Where:
M_{CaCO3}=Mass of CaCO₃ in the sample
DM₁₀₀₀=Mass loss at 1000° C. in %
DM₅₅₀=Mass loss at 550° C. in %

$${CO 2}_{SEQ} = D {M}_{CaCO 3} * NORM * 10$$

Where:
CO2_{SEQ}=Mass of CO₂ sequestered in g/kg aggregate
DM_{CaCO3}=Net new carbonate (M_{CaCO3} Treated sample −M_{CaCO3} Non-treated sample)
NORM=Normalization factor according to ignited mass (ignited mass of non-treated sample/ignited mass of treated sample)

### 2. CO₂ Used

How efficiently each treatment uses the CO₂ can be determined using the test procedure described above and/or mass change of the RCA during treatment, or any other suitable technique. Once the efficiency of each treatment has been determined, the amount of CO₂ used during the treatment may be used to determine the amount sequestered in the RCA. The efficiency of each treatment may be affected by material properties such as aggregate moisture content, size, and age, as well as treatment parameters such as duration, CO₂ flow rate, and pressure. Other material properties and/or treatment parameters may also affect the treatment efficiency. The treatment efficiency must be determined by using either Method 1 described above or mass change of the sample, or other suitable technique. Once the efficiency is established for the equipment, the among of CO₂ used during treatment is multiplied with the treatment efficiency to show how much CO₂ was sequestered. This number can then be normalized to the weight of aggregate (g/kg agg) or cement (g/kg cem) as relevant and/or information are available.

The following equation can be used:

$${CO 2}_{SEQ} = ( {M}_{CO 2} * EFF ) / {M}_{AGG}$$

Where:
CO2_{SEQ}=Mass of CO₂ sequestered in g/kg aggregate
M_{CO2}=mass of CO₂ used during treatment
EFF=Efficiency of the treatment (a value between 0 and 1)
M_{AGG}=mass of aggregate

### 3. Change in Moisture Content:

When RCA is exposed to CO₂, the carbon dioxide reacts with the cement paste to produce calcium carbonate (CaCO₃). This reaction will also produce water, which will increase the moisture content of the aggregate and/or the ambient relative humidity within a treatment vessel. In treatment where the RCA is not immersed in water or solution, the carbonation reaction will increase the moisture content of the RCA. This increase in moisture content can be related to the amount of CO₂ sequestered. As shown below, it will depend on which formation in the cement paste is reacting with the CO₂ how many units of water are formed for a unit of CO₂ reacted. However, it can be estimated that for each unit of CO₂ sequestered approximately three units of water are formed. The moisture content of the RCA is determined before the treatment as well as after the treatment. The difference in moisture content is then converted to amount of CO₂ using the ratio of the molar masses of H₂O and CO₂.

### 2C—S—H Gel:

$$1.7 CaO \cdot SiO2 \cdot 4 H2O + \text{} 0.3 Ca ( OH ) 2 + \text{} 2 CO2 \to \text{} 2 CaCO3 + \text{} SiO2 + 4.3 H2O Ratio of \text{} H2O / CO2 = 2.2$$

### 3C—S—H Gel

$$1.7 CaO \cdot SiO2 \cdot 4 H2O + 1.29 Ca ( OH ) 2 + 3 CO2 \to 3 CaCO3 + SiO2 + 5.31 H2O Ratio of H2O / CO2 = 1.8$$

### Tob C—S—H Gel

$$0.83 CaO \cdot SiO2 \cdot 1.3 \text{} H2O + \text{} 0.17 \text{} Ca ( OH ) \text{} 2 + \text{} CO2 \to CaCO3 + \text{} SiO2 + 1.4 H2O Ratio of H2O / CO2 = 1.4$$

### Jen C—S—H Gel

$$1.67 CaO \cdot SiO2 \cdot 2.1 H2O + 0.33 Ca ( OH ) 2 + 2 CO2 \to 2 CaCO3 + SiO2 + 2.44 H2O Ratio of H2O / CO2 = 1.2$$

Moisture content of the aggregate is used to calculate the available water in the aggregate before and after CO2 treatment:

$${M}_{H 2 O} = {M}_{AGG} * ( MC \% / 100 )$$

$${M}_{CO 2} = ( DH 2 O * 0.8148 ) * / {M}_{AGG}$$

Where:
M_{H2O}=mass of available water in aggregate
M_{AGG}=mass of aggregate
MC %=moisture content of aggregate in %
CO2_{SEQ}=Mass of CO₂ sequestered in g/kg aggregate
DH2O=Change in available water content during treatment

### Correlation of the Methods

All three methods were used to estimate the uptake of an RCA sample during a large-scale trial. The results are shown in the table below and show good correlation within. The efficiency of the trial treatment was determined to be 65%, i.e. 65% of the CO₂ used was sequestered in the RCA.

| | Method 1: | Method 2: | Method 3: |
|---|---|---|---|
| | Furnace | Mass of CO₂ | Change in |
| | testing | used | moisture |
| CO₂ uptake (%) | 0.77 | 0.79 | 0.87 |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A method for carbonating recycled concrete aggregate (RCA) comprising exposing the RCA to carbonated water.

2. The method of claim 1 further comprising treating the RCA to produce particles of RCA.

3. The method of claim 2 further comprising separating the particles of RCA into one or more desired size or sizes or range or ranges of sizes.

4. The method of claim 3 further comprising determining the degree to which the particles of RCA can be carbonated.

5. The method of any one of the preceding claims wherein the RCA is contained in a watertight or substantially watertight vessel.

6. The method of claim 5 wherein the vessel is open to the atmosphere.

7. The method of claim 5 wherein the RCA is completely immersed in carbonated water.

8. The method of claim 1 wherein the RCA is unconfined.

9. The method of any one of claims 5 to 8 further comprising causing carbonated water to move through the RCA.

10. The method of claim 9 wherein the RCA is unconfined and causing the carbonated water to move through the RCA comprises contacting the unconfined RCA with the carbonated water in such a way that the carbonated water percolates down through the unconfined RCA in a uniform or substantially uniform manner, emerging at the bottom of the unconfined RCA.

11. The method of claim 9 wherein the RCA is confined and causing the carbonated water to move through the RCA comprises introducing carbonated water at or near the surface of the water in which the RCA is immersed in a uniform or substantially uniform manner and causing the water to flow through the immersed RCA to an exit site that is at or near the bottom of the immersed RCA.

12. The method of claim 9 further comprising separating or substantially separating water that has moved through the RCA from the RCA to create a pool of separated water.

13. The method of claim 12 further comprising contacting water from the pool of separated water with carbon dioxide.

14. The method of claim 13 further comprising transporting water as it is being exposed to carbon dioxide back to the RCA.

15. The method of claim 14 wherein the transporting occurs in one or more conduits, wherein the water flows in the conduit or conduits from the pool to one or more sprayers or other mechanism to distribute the re-carbonated water back to the RCA.

16. The method of claim 14 further comprising determining one or more characteristics of
(a) a difference between a first and a second pH of water, wherein the first pH is of the water before re-carbonation, e.g., pH in the pool, and the second pH is of the water after re-carbonation of the water, e.g., just before it is distributed back to the RCA;
(b) water temperature at one or more points;
(c) non-H+ ion activity of water at one or more points;
(d) time of treatment.

17. The method of claim 16 further comprising determining, based at least in part on the one or more characteristics, whether or not to modulate flow of water and/or carbon dioxide.

18. The method of claim 17 wherein determining comprises determining to stop flow of both water and carbon dioxide, and communicating to one or more actuators, such as valves, to stop the flow.

19. An system for carbonating recycled concrete aggregates comprising
(i) a pile of unconfined RCA, wherein the RCA is present as particles in a desired size or range of sizes and comprises atop, a bottom, and an outer surface;
(ii) a source or sources of water;
(iii) one or more conduits operably connected to the source or sources of water and to one or more water distribution systems, wherein the one or more conduits further comprise a system for contacting the water with carbon dioxide as it moves through the conduit;
(iv) a source of motive power, e.g., a pump, to move the water through the conduit from the source to the one or more water distribution systems, and out of the one or more water distribution systems onto at least part of the outer surface of the pile, so that the carbonated water percolates through the pile, emerging at the bottom of the pile.

20. The system of claim 19 wherein the one or more water distribution systems comprise one or more sprayers.

21. The system of claim 19 or claim 20 wherein the one or more water distribution systems, e.g., sprayers are situated so that water that emerges from the one or more water distribution systems, e.g, sprayers and contacts the outer surface percolates through the pile of RCA in a uniform or substantially uniform manner.

22. The system of any one of claims 19 to 21 comprising a plurality of water distribution systems, e.g, sprayers, e.g., 2, 3, 4, 5, 6, 7, 8, 9, 10 or more than 10.

23. The system of any one of claims 19 to 21 further comprising
(v) a vessel to collect the water that emerges from the bottom of the pile to create a source of water.

24. The system of any one of claims 19 to 23 wherein the one or more conduits each has a length, and wherein the system to contact the water with carbon dioxide in a conduit comprises less than 80, 70, 60, 50, 40, 30, 20, or 10% of the length of that conduit and is situated at or near the connection of the conduit to the source of water.

25. The system of any one of claims 19 to 24 wherein the system for contacting the water with carbon dioxide comprises a connecting conduit for transporting carbon dioxide from a source of carbon dioxide to the one or more conduits and connected to the one or more conduits in such a manner as to provide contact between the carbon dioxide and the water.

26. The system of claim 25 wherein the carbon dioxide flows from the connecting conduit to a conduit disposed within the one or more conduits and configured to allow the carbon dioxide to contact the water.

27. The system of any one of claims 19 to 26 further comprising a first pH sensor to determine a first pH of water at the source, i.e., after it has percolated through the RCA but before it is re-carbonated, and a second sensor to determine a second pH of water after it is re-carbonated.

28. The system of any one of claims 19 to 27 further comprising a controller for controlling the system.

29. The system of claim 28 wherein the controller is configured to adjust flow of carbon dioxide to the system to contact the water with carbon dioxide and/or flow of water through the conduit, based at least in part on one or more of
(a) the difference between the first pH and the second pH;
(b) the time that flow has occurred;
(c) the volume of water flowed onto the pile;
(d) a first and second temperature
(e) a first and second non-H+ ion content.

30. The system of claim 29 wherein the controller adjust flow based, at least in part, on the difference between the first and second pHs.

31. The system of any one of claims 19 to 30 comprising a plurality of unconfined piles, each of which comprises (ii) a source or sources of water;
(iii) one or more conduits operably connected to the source or sources of water and to one or more water distribution systems, wherein the one or more conduits further comprise a system for contacting the water with carbon dioxide as it moves through the conduit;
(iv) a source of motive power, e.g., a pump, to move the water through the conduit from the source to the one or more water distribution systems, and out of the one or more water distribution systems onto at least part of the outer surface of the pile, so that the carbonated water percolates through the pile, emerging at the bottom of the pile.

32. The system of claim 31 wherein the plurality of piles comprises at least 2, 3, 4, 5, 6, 7, 8, 9, 10 piles.

33. The system of claim 31 or claim 32 further comprising a system to transport water that emerges from the bottoms of at least a portion of the plurality of piles to a common vessel.

34. A system for carbonating recycled concrete aggregates comprising
(i) a vessel to contain RCA and carbonated water in which the RCA is immersed, wherein
(a) the RCA is present as particles in a desired size or range of sizes;
(b) the water has a top surface
(c) the containment vessel is watertight or substantially watertight.
(ii) a water collection pool separated from the RCA by a permeable layer and, optionally, an impermeable layer;
(iii) one or more conduits operably connected to the water collection pool and to one or more water distribution systems, e.g., sprayers, situated to distribute water from the one or more water distribution systems, e.g. sprayers, to or near the top surface of the water;
(iv) a source of motive power, e.g., a pump, to move the water through the conduit from the source to the one or more sprayers, and out of the one or more sprayers.

35. The system of claim 34 comprising both a permeable layer and an impermeable layer.

36. The system of claim 35 wherein the permeable layer is situated below the impermeable layer.

37. The system of claim 36 wherein the permeable layer is configured and situated so that only water from the bottom 5, 10, 15, 20, 25, 30, 40, 50, 60%, e.g, bottom 15%, of the RCA can move through it to the water collection pool.

38. The system of any of claims 34-37 further comprising a system for contacting the water with carbon dioxide as it moves through the conduit or conduits.

39. The system of claim 38 wherein the conduit or conduits each has a length, and wherein the system to contact the water with carbon dioxide comprises less than 80, 70, 60, 50, 40, 30, 20, or 10% of the length of a particular conduit and is situated at or near the connection of the conduit to the source of water.

40. The system of claim 38 or claim 39 wherein the system for contacting the water with carbon dioxide comprises a connecting conduit for transporting carbon dioxide from a source of carbon dioxide to the one or more conduits and connected to the one or more conduits in such a manner as to provide contact between the carbon dioxide and the water.

41. The system of claim 40 wherein the carbon dioxide flows from the connecting conduit to a conduit disposed within the one or more conduits and configured to allow the carbon dioxide to contact the water.

42. The system of any one of claims 34 to 41 further comprising a vessel to which water from the collection area is transported, and to which is connected the conduit

43. A method comprising
(i) placing unused wet concrete in a vessel;
(ii) contacting the unused wet concrete with carbon dioxide while the unused wet concrete is mixing to carbonate the used wet concrete, producing carbonated unused wet concrete; and
(iii) removing the carbonated unused wet concrete from the vessel.

44. The method of claim 43 further comprising
(iv) placing the carbonated unused wet concrete on a surface at a first site in a layer of desired thickness;
(v) allowing the carbonated unused concrete to set and harden; and
(vi) treating the hardened concrete to divide it into smaller portions.

45. The method of claim 44 further comprising
(vii) transporting the smaller portions to a second site

46. The method of claim 45 further comprising
(viii) allowing the smaller portions to continue to harden until a desired hardness is reached and/or a desired period of time has elapsed to produce hardened portions; and
(ix) treating the hardened portions to create smaller particles, e.g., for use as aggregates.

47. The method of claim 46 further comprising
(x) separating the smaller particles into a desired size or range of sizes to produce sized hardened carbonated unused concrete.

48. The method of claim 47 further comprising using the sized hardened carbonated unused concrete as aggregate in a subsequent batch of concrete, and/or as road way filler.

49. A system for carbonating unused wet concrete comprising
(i) a vessel to hold and mix the unused wet concrete;
(ii) an apparatus to introduce a source of carbon dioxide to the unused wet concrete, thereby producing carbonated unused wet concrete.

50. The system of claim 49 wherein the source of carbon dioxide comprises solid and gaseous carbon dioxide that is contacted with the mixing unused wet concrete.

51. The system of claim 49 or claim 50 further comprising
(iii) a system to remove carbonated unused wet concrete from the vessel.

52. The system of claim 51 further comprising
(iv) a system for spreading the carbonated unused wet concrete on a surface to a desired thickness at a first site.

53. The system of claim 52 further comprising
(v) a system for reducing the carbonated unused wet concrete into smaller portions after the carbonated unused wet concrete has set and hardened.

54. The system of claim 53 further comprising
(vi) a system for moving the smaller portions produced in (v) to a second site, where they can continue to harden.

55. The system of claim 54 further comprising
(vii) a system to reduce sizes of the smaller portions to produce particles of the hardened carbonated concrete and to separate the particles into particles of a desired size or range of sizes.
